(19) United States
(12) Patent Application Publication
(10) Pub. No.: US 2005/0013585 A1
(43) Pub. Date: Jan. 20, 2005

(54) Communication apparatus, communication information recording method and memory medium

(75) Inventor: Yasumasa Ono, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/920,772

(22) Filed: Aug. 17, 2004

Related U.S. Application Data
(63) Continuation of application No. 09/344,111, filed on Jun. 24, 1999.

(30) Foreign Application Priority Data
Jun. 24, 1998 (JP) 10-192320
Jun. 23, 1999 (JP) 11-176280

(51) Int. Cl. H04N 5/76; H04N 5/781

(52) U.S. Cl. 386/46; 386/125

(57) ABSTRACT

In a message telephone/VTR system, the message telephone has a system control unit for judging presence or absence of reception of a TV telephone call from the public line, and, in case of reception of the TV telephone call, transmitting packet data, generated by decoding the audio/image data, and a recording start/stop command to the VTR through the I/F, and the VTR of the system has a system control unit for controlling the start/stop of recording based on the packet data and the recording start/stop command transmitted from the system control unit.

### BACKGROUND OF THE INVENTION

1. Field of the Invention

The present invention relates to a communication apparatus, a communication information recording method and a memory medium, and more particularly to a communication information recording method and a memory medium adapted for recording an externally received image signal such as a TV telephone signal.

2. Related Background Art

There is already known a telephone with a message recording function for recording the voice of an external telephone call, when the user of the telephone is not available. For realizing such message recording function, the telephone set is provided with a function of audio recording and the audio signal alone is recorded by such function when the user is not available.

The above-described prior technology has been associated with the following drawback. The telephone set has to be provided with an image signal recording function for recording the image signal in addition to the above-mentioned audio recording function, in case an image signal for example by a TV telephone is transmitted from the outside, namely in case an image signal is added to the audio signal.

### SUMMARY OF THE INVENTION

An object of the present invention is to solve the above-described drawback.

Another object of the present invention is to enable recording of the received image without the image signal recording function in the telephone itself.

Still another object of the present invention is to provide a communication apparatus, a communication information recording method and a memory medium, enabling a message recording function for a television telephone even without the function for recording the image signal in the telephone itself, by recording the image signal such as of television telephone by a recording apparatus such as a video cassette recorder.

Still another object of the present invention is to provide a communication apparatus, a communication information recording method and a memory medium, enabling the reproduction of the recorded message information by the operation on the telephone set only, in case the recording apparatus such as the video cassette recorder is utilized for recording the image signal such as of television telephone.

The above-mentioned objects are attained, according to the present invention, by a communication apparatus capable of receiving the communication information from the exterior, comprising discrimination means for discriminating the presence or absence of communication information, and control means for enabling, in case the communication information is received, a recording apparatus capable of recording the communication information.

The present invention is further featured by that the discrimination means has a function for discriminating whether the communication information is an image signal, and the control means executes a control to initiate the recording by the recording apparatus in case the communication information is identified as the image signal.

Still other objects of the present invention, and the features thereof, will become fully apparent from the following description of the embodiments which is to be taken in conjunction with the attached drawings.

### BRIEF DESCRIPTION OF THE DRAWINGS

FIG. 1 is a block diagram showing the configuration of a message telephone/VTR system in the first and second embodiments of the present invention;

FIG. 2 is a flow chart showing a reception process and a recording start/stop process in the message telephone/VTR system of the first embodiment of the present invention;

FIG. 3 is a flow chart showing a reception process and a recording start/stop process in the message telephone/VTR system of the second embodiment of the present invention;

FIG. 4 is a view showing the configuration of CIF format and QCIF format in a common video format H.261 in the first embodiment of the present invention;

FIG. 5 is a block diagram showing an example of the network system constituted with 1394 serial buses in the first embodiment of the present invention;

FIG. 6 is a block diagram showing the components of the 1394 serial bus in the first embodiment of the present invention;

FIG. 7 is a view showing the address space in the 1394 serial buses in the first embodiment of the present invention;

FIG. 8 is a cross-sectional view of the 1394 serial buses in the first embodiment of the present invention;

FIG. 9 is a timing chart showing the DS-Link encoding method for the data transfer format employed in the 1394 serial bus of the first embodiment of the present invention;

FIG. 10 is a view showing hierarchic structure of nodes in the first embodiment of the present invention;

FIGS. 11A and 11B are views showing arbitration in the first embodiment of the present invention, wherein FIG. 11A shows a bus use request while FIG. 11B shows a bus use permission;

FIG. 12 is a timing chart showing transitions of state in time in the asynchronous transfer in the first embodiment of the present invention;

FIG. 13 is a view showing an example of the packet format for the asynchronous transfer in the first embodiment of the present invention;

FIG. 14 is a timing chart showing transitions of state in time in the isochronous transfer in the first embodiment of the present invention;

FIG. 15 is a view showing an example of the packet format for the isochronous transfer in the first embodiment of the present invention;

FIG. 16 is a timing chart showing transitions of state in time in the transfer state on the bus on which isochronous and asynchronous transfers in the first embodiment of the present invention are mixedly present;

FIG. 17 is a flow chart showing serial bus operations from the generation of bus resetting to the determination of node ID for enabling data transfer, in the first embodiment of the present invention;

FIGS. 18 and 19 are flow charts showing details of the sequence from bus resetting to root determination, in the first embodiment of the present invention;

FIGS. 20, 21 and 22 are flow charts showing details of the sequence after root determination to ID setting, in the first embodiment of the present invention;

FIGS. 23 and 24 are flow charts showing the sequence of arbitration in the first embodiment of the present invention;

FIG. 25 is a block diagram of a video camera for generating a message telephone response signal in the third embodiment;

FIG. 26 is an external view of a video camera for which the operator himself constitutes the object to generate the message telephone response signal in the third embodiment; and

FIG. 27 is a flow chart showing the operations of the third embodiment.

### DETAILED DESCRIPTION OF THE PREFERRED EMBODIMENTS

Now the present invention will be clarified in detail by preferred embodiments, with reference to the attached drawings.

### [1] First Embodiment

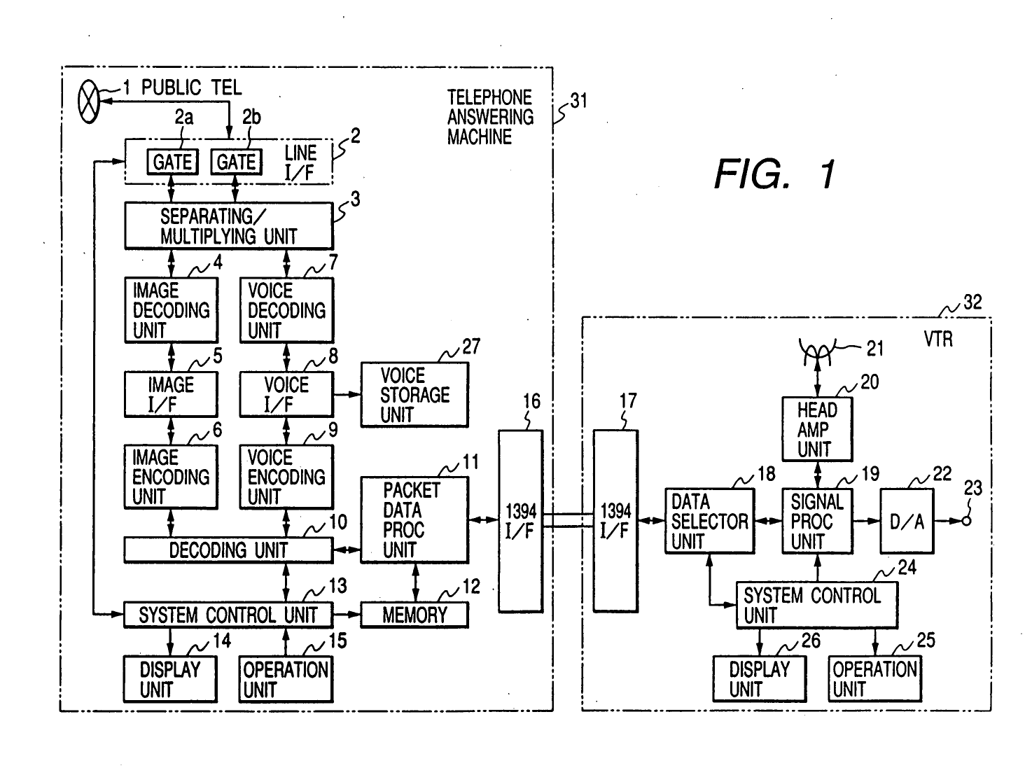

FIG. 1 is a block diagram showing the configuration of a message telephone/VTR system in the first and the second embodiments of the present invention. The system in the first embodiment is principally composed of a message telephone (or telephone answering machine) 31 and a video tape recorder (VTR) 32.

The message telephone 31 is provided with a line interface (I/F) unit 2, a separation/multiplexing unit 2, an image decoding unit 4, an image I/F 5, an image encoding unit 6, an audio decoding unit 7, an audio I/F 8, an audio encoding unit 9, a decoding unit 10, a packet data generation unit 11, a memory 12, a system control unit 13, a display unit 14, an operation unit 15, a 1394 I/F 16, and an audio memory unit 27. Also the VTR 32 is provided with a 1394 I/F 17, a data selector 18, a signal process unit 19, a head amplifier 20, a head unit 21, a D/A converter 22, an external output unit 23, a system control unit 24, an operation unit 25 and a display unit 26. The configuration shown in FIG. 1 is merely an example and is not limited to the illustrated one.

The various units of the message telephone 31 function as follows. The line I/F 2 is provided with gates 2a, 2b for connecting with a public line 1. The separation/multiplexing unit 2 separates or multiplexes the output from the gates 2a, 2b of the line I/F 2. The image decoding unit 4 decodes the image data. The image I/F 5 transmits the decoded image to the image encoding unit 6, which encodes the image data. The audio decoding unit 7 decodes the audio data. The audio I/F 8 transmits the decoded audio to the audio encoding unit 9, which encodes the audio data. The decoding unit 10 decodes the image and audio data. The packet data generation unit 11 generates packet data, based on the output of the decoding unit 10.

The memory 12 stores the data from the packet data generation unit 11. The system control unit 13 controls the entire message telephone. The display unit 14 displays a telephone number, a message etc. under the control of the system control unit 13. The operation unit 15 is provided with numeral and other keys and is used for operating or setting the message telephone. The 1394 I/F 16 controls the serial communication based on the IEEE (Institute of Electric and Electronics Engineers) 1394 standard. The audio memory unit 27 stores the audio data.

Also the units constituting the VTR 32 function as follows. The 1394 I/F 17 controls the serial communication based on the IEEE 1394 standard. The data selector 18 selects the data from the 1394 I/F 17. The signal processing unit 19 processes the recording and reproduced signals of the VTR. The head amplifier 20 drives the head unit 21 for effecting the recording or reproducing operation. The head unit 21 executes recording on or reproduction from a magnetic tape. The D/A converter 22 converts the digital data from the signal processing unit 19 into analog data. The external output unit 23 is composed for example of external output terminals of the VTR 32. The system control unit 24 controls the entire VTR. The operation unit 25 is provided with various keys and buttons, and is used for the operation and setting of the VTR. The display unit 26 displays numerals etc. under the control by the system control unit 24.

In such configuration, the system control unit 13 of the message telephone 31 in the first and second embodiments corresponds to the discrimination means and the control means in the appended claims; also the 1394 I/F 16 of the message telephone 16 corresponds to the transmission means in the appended claims; and the VTR 31 corresponds to the recording apparatus in the appended claims.

In the message telephone/VTR system of the first embodiment of the present invention, there will be explained, as an example, a case of employing the IEEE 1394 interfaces as the network for connecting the message telephone 31 and the VTR 32. At first there will be given an explanation on the IEEE 1394 serial bus.

[Outline of IEEE 1394 Technology]

With the development of home-use digital VTR and DVD (digital video disk), there is being required to support the transfer of data of a large amount such as video data or audio data on real-time basis. For transferring such video data or audio data on real-time basis, fetching such data into a personal computer or effecting transfer to other digital equipment, there is required an interface capable of high-speed data transfer with required transfer functions. For this purpose there has been developed the IEEE 1394-1995 interface (high performance serial bus) (hereinafter represented as 1394 serial bus).

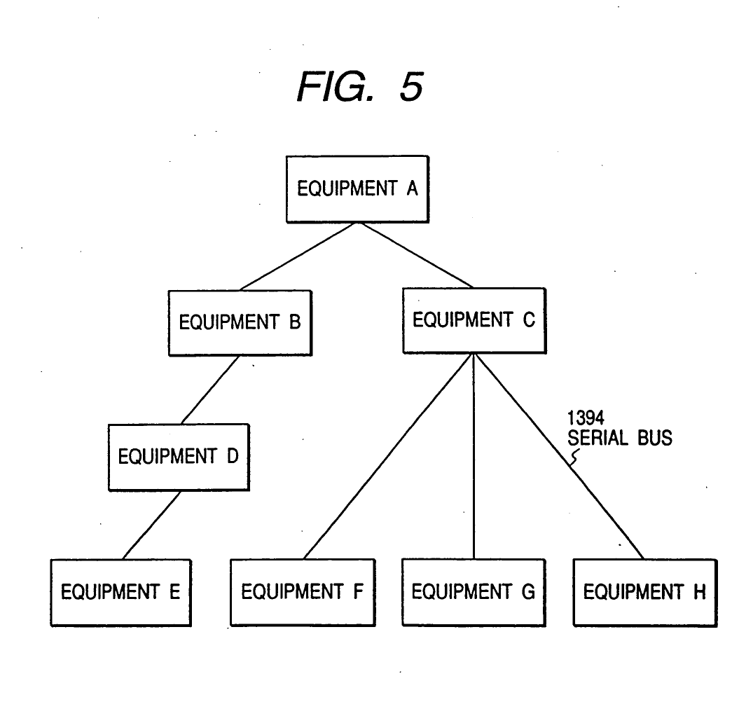

FIG. 5 shows an example of the network system constituted with the 1394 serial buses. The system contains plural digital equipment A, B, C, D, E, F, G and H, and a twisted pair cable of the 1394 serial bus is used for making connections A-B, A-C, B-D, D-E, C-F, C-G and C-H. The digital equipment A to H are, for example, a personal computer, a digital VTR, a DVD, a digital camera, a hard disk, a monitor etc. The connections among the digital equipment are a mixture of daisy chain connection and node branched connection, and the connections can be with high flexibility.

The digital equipment A to H are respectively given specific ID's, which are mutually recognized to constitute a single network within the range of connection by the 1394 serial buses. The unified network can be constituted by merely connecting each of the digital equipment with a 1394 serial bus cable, whereby each equipment performs the function of relaying. Also based on the plug and play function (automated mechanism on the interruption signal and the setting of I/O port address) featuring the 1394 serial bus, there is automatically executed the recognition of the equipment and the connection status thereof when the cable is connected to the equipment.

Also in the network system as shown in FIG. 5, when an equipment is deleted therefrom or newly added thereto, a bus resetting is automatically executed to reset the network configuration and the configuration of the network is constructed anew. This function allows to always set and recognize the current configuration of the network.

Also it has data transfer rates 100/200/400 Mbps, and an equipment having the higher transfer rate supports the lower transfer rate for achieving compatibility. There are provided two data transfer modes, namely “isochronous transfer mode” for transferring asynchronous data (hereinafter represented as async data) such as control signals, and “asynchronous transfer mode” for transferring isochronous data (hereinafter represented as iso data) such as real-time video or audio data. The async data and iso data are mixedly transferred within a predetermined communication cycle (usually 125 μs) after the transfer of a cycle start packet (CSP) indicating the start of a cycle and with priority given to the transfer of the iso data.

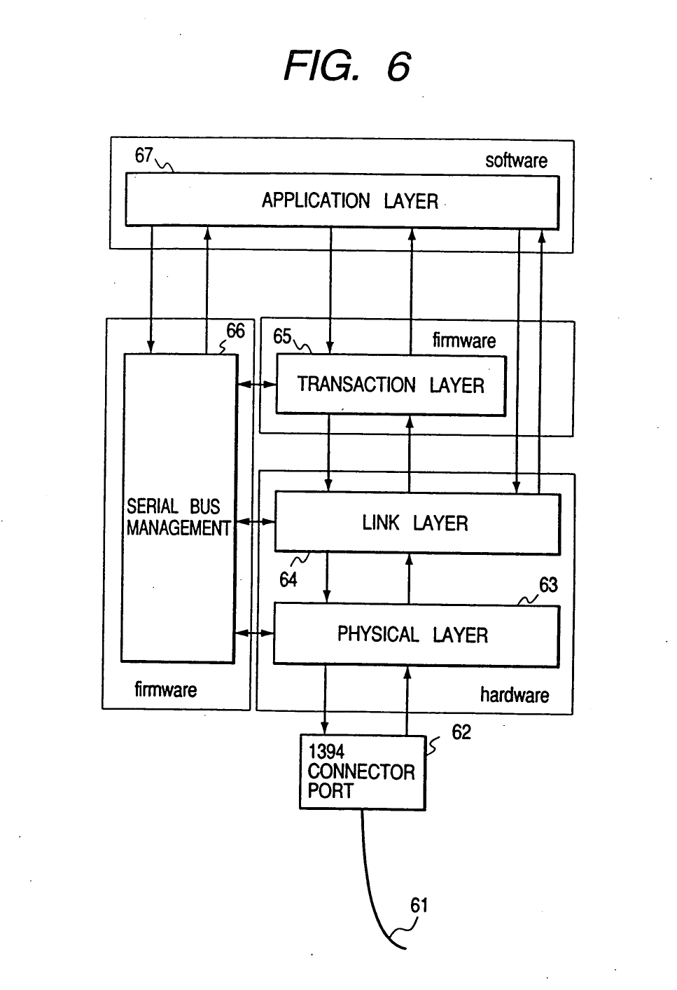

FIG. 6 shows the components constituting the 1394 serial bus, which has a layer (hierarchic) structure. As shown in FIG. 6, there are provided a cable 61 for the 1394 serial bus, of which connector is connected to a 1394 connector port 62, on which provided as hardware are a physical layer 63 and a link layer 64.

The hardware is substantially constituted by an interface chip, in which the physical layer 3 executes controls related to the encoding and to the connector, while the link layer 64 executes controls related to the packet transfer and the cycle time. A transaction layer 65 in a firmware portion manages the data to be subjected to transfer (transaction), and issues commands such as read and write. A serial bus management 66 manages the connection status and ID of the connected equipment, thereby managing the configuration of the network. These hardware and firmware practically constitute the 1394 serial bus. An application layer 67 in a software portion is variable depending on the software to be used, defines how the data are to be used in the interface and is defined by a protocol such as AV protocol. The 1394 serial bus is constructed in the above-described manner.

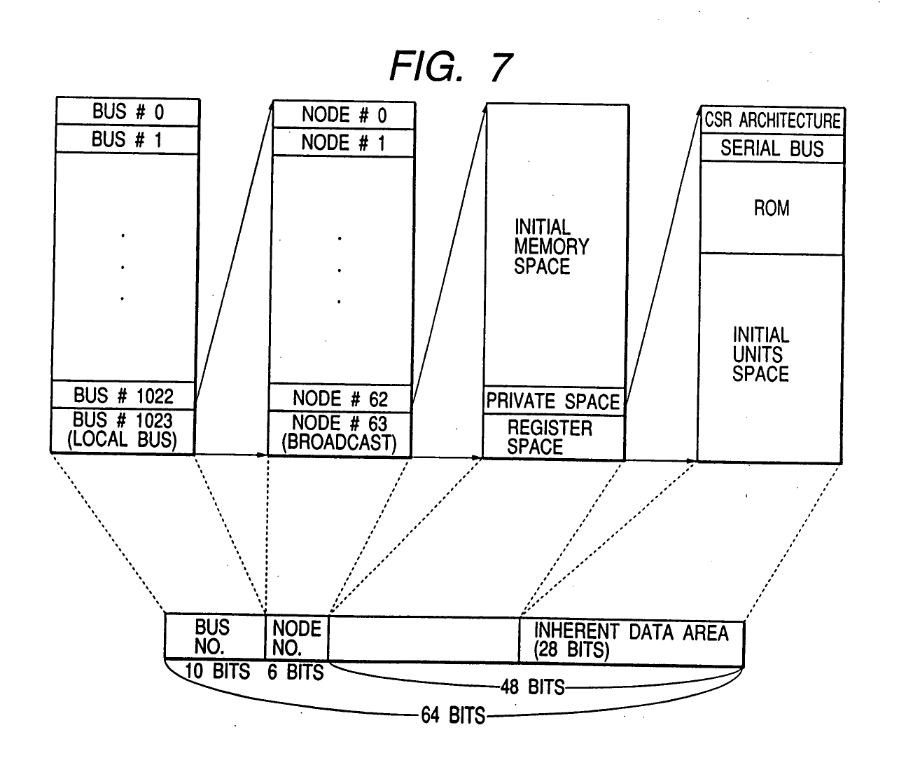

FIG. 7 shows the address space of the 1394 serial bus. Each equipment (node) connected to the 1394 serial bus is always given a 64-bit address specific to such node. Such address is stored in a ROM, so that the node address of own or another node can be always confirmed, and there can be executed communication designating the partner. The addressing of the 1394 serial bus is based on the IEEE 1212 standard, and the initial 10 bits are used for designating the bus number, while the next 16 bits are used for designating the node ID number, and the remaining 48 bits are an address width given to the equipment, usable as a specific address space. The last 28 bits are used as a specific data area, for storing information for identifying each equipment or designating the condition of use. The 1394 serial bus technology is principally constructed as explained in the foregoing.

In the following there will be given a more detailed explanation on the technology featuring the 1394 serial bus.

[Electric Specification of the 1394 Serial Bus]

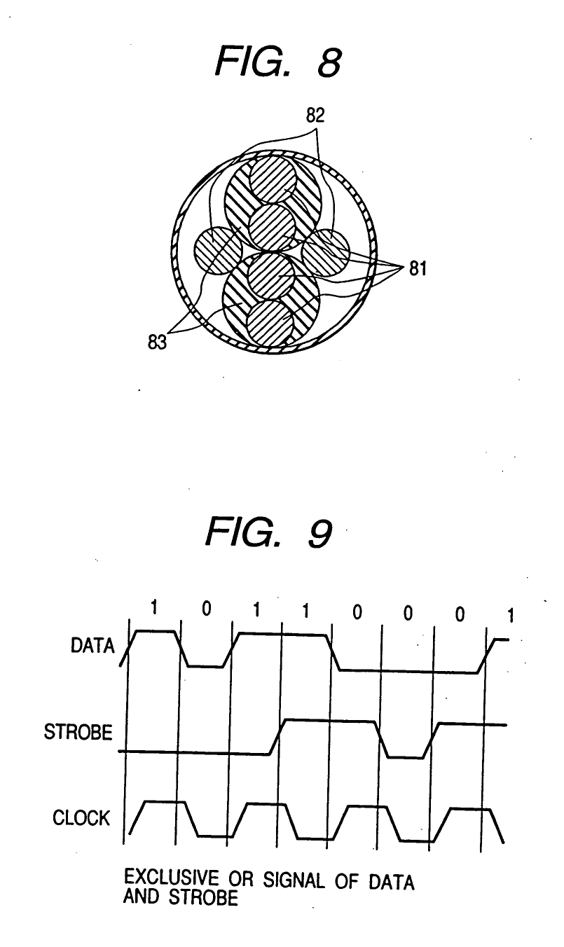

FIG. 8 is a cross-sectional view of the 1394 serial bus cable, containing two sets of twisted pair signal lines 81 and a power supply line 82 (8 to 40 V, maximum current 1.6 A), thereby enabling power supply to a equipment not provided with power source therein or showing a voltage lowering because of a failure. There is also shown a signal line shield 83.

[DS-link Encoding]

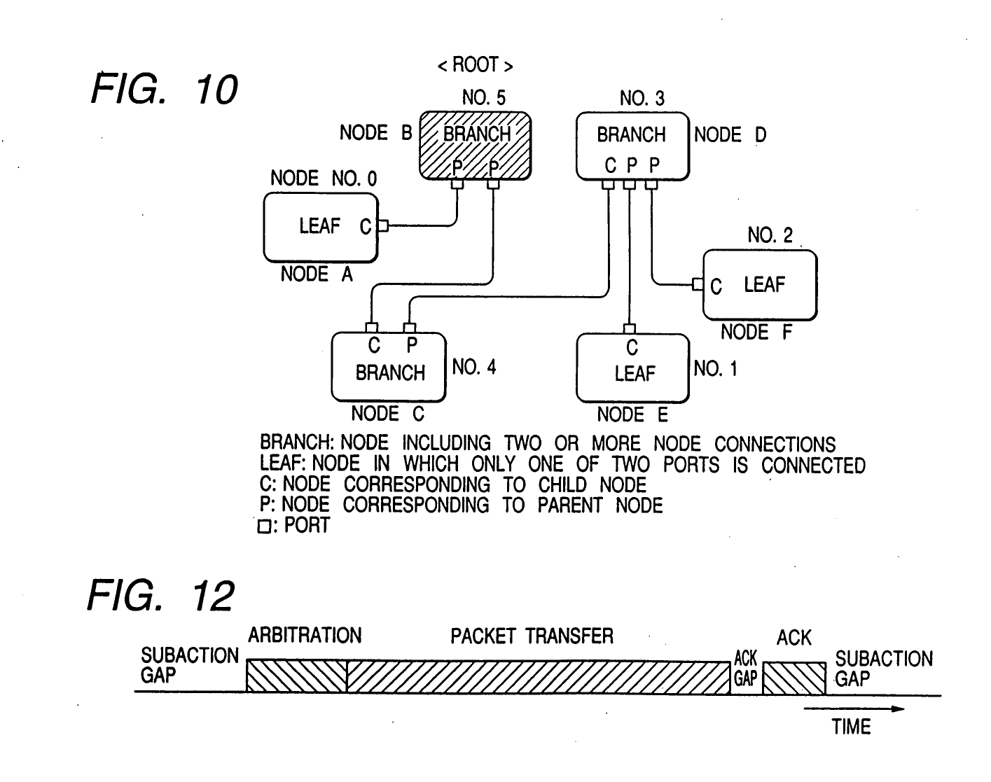

FIG. 9 is a timing chart for explaining the DS-link encoding method for the data transfer format employed in the 1394 serial bus. The DS-link encoding method employed therein is suitable for high-speed serial data communication, which requires two signal lines. One of the twisted pair signal lines is used for transmitting the main data and the other is used for transmitting strobe signal.

The receiving side can reproduce the clock signal by forming the exclusive logic sum of the communicated data and the strobe signal. The DS-link encoding method has various advantages such as a higher transfer efficiency in comparison with other serial data transfer methods, a smaller circuit magnitude of the controller LSI because the phase locked loop circuit can be dispensed with, and a lower electric power consumption by maintaining the transceiver circuit of each equipment in the sleep state because it is unnecessary to send information indicating the idle state in the absence of the data to be transferred.

[Bus Resetting Sequence]

In the 1394 serial bus, each connected equipment (node) is given a node ID and is recognized as a constituent of the network. When it becomes necessary to recognize the network configuration anew by a change in the network configuration, for example a change in the number of nodes by deletion or addition of a node or by an on/off operation of the power supply, each node detecting such change transmits a bus resetting signal on the bus, thereby entering a mode for recognizing the new network configuration. The detection of the change is achieved by detecting a change in the bias voltage on the 1394 port board.

Receiving the bus resetting signal from a node, the physical layer of each node simultaneously transmits the generation of bus resetting to the link layer and also transmits the bus resetting signal to other nodes. The bus resetting is activated after the bus resetting signal is detected by all the nodes. The bus resetting is activated by a hardware detection such as the insertion or extraction of a cable or an abnormality in the network, or by a direct command to the physical layer for example from a host equipment according to the protocol. The data transfer is interrupted with the activation of bus resetting and is restarted, after the bus resetting, under the new network configuration.

[Node ID Determination Sequence]

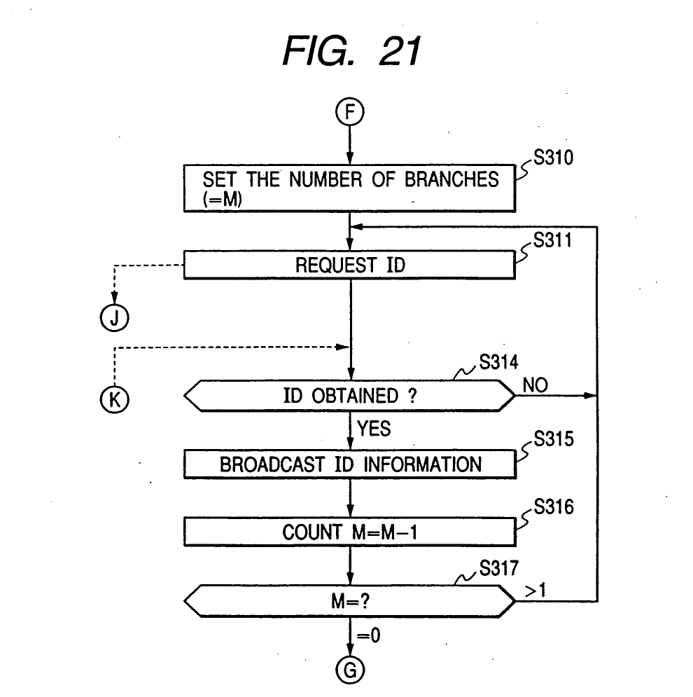

After the bus resetting, the nodes enter an operation of giving ID's thereto for constructing the new network configuration. The general sequence from the bus resetting to the node ID determination will be explained with reference to flow charts shown in FIGS. 17, 18, 19, 20, 21 and 22.

The flow chart in FIG. 17 shows a series of bus operations from the generation of bus resetting to the determination of node ID whereupon the data transfer is enabled. At first a step S101 constantly monitors the generation of a bus resetting in the network. When a bus resetting is generated for example by a power on/off operation of the node, a step S102 executes declaration of the parent-child relationship between the directly connected nodes in order to know the connection status of the new network. When the parent-child relationship is determined among all the nodes in a step S103, a step S104 determines a root. The declaration of the parent-child relationship in the step S102 is executed and the root is not determined, until the parent-child relationship is determined among all the nodes.

After the root determination in the step S104, a step S105 executes a node ID setting operation for giving ID to each node. The node ID setting operation is repeated with a predetermined order of nodes, until all the nodes are given ID's. When a step S106 identifies the completion of ID setting in all the nodes, the new network configuration is recognized by all the nodes to enable data transfer among the nodes, and a step S107 executes the data transfer. In the state of the step S107, there is again entered the mode of monitoring the generation of bus resetting, and, if a bus resetting is generated, the setting operations of the steps S101 to S106 are repeated.

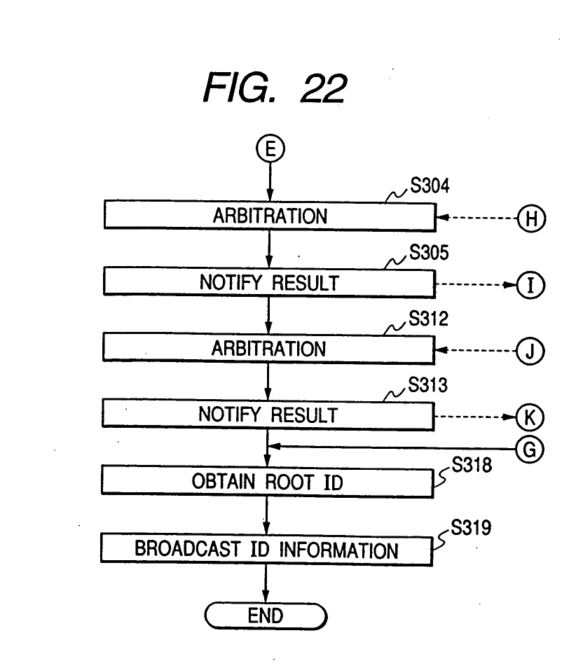

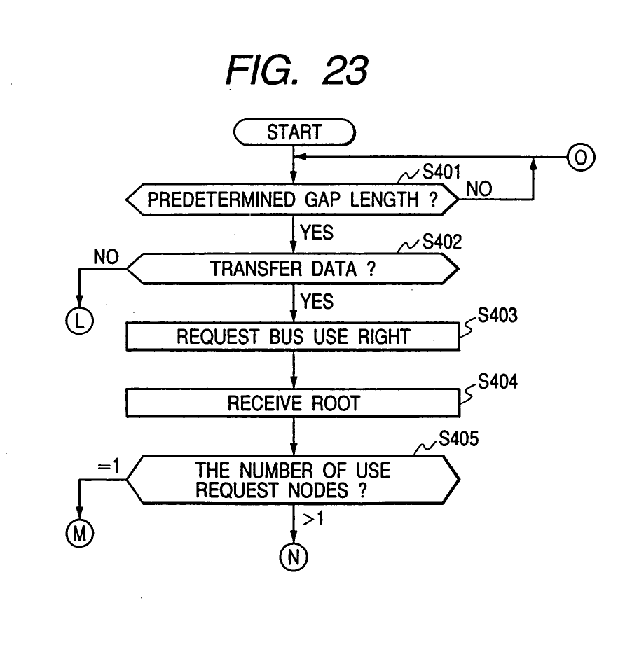

The flow charts in FIGS. 18 and 19 and those in FIGS. 20 to 22 respectively show, in more details, a part of the flow chart in FIG. 17 from the bus resetting to the root determination and a part thereof after the root determination to the completion of ID setting.

At first there will be explained the flow charts shown in FIGS. 18 and 19. When a bus resetting occurs in a step S201, the network configuration is once reset. The step S201 constantly monitors the generation of the bus resetting. Then a step S202 sets, in each equipment, a flag indicating that the equipment is a leaf (node), as a first step of the operation for re-recognizing the connection request of the network thus reset. Then, in a step S203, each equipment checks the number of nodes to which the port of the equipment is connected.

According to the result indicating the number of ports in the step S204, there is checked the number of undefined ports (for which the parent-child relationship is not determined) in order to start the declaration of the parent-child relationship. The number of ports is equal to the number of undefined ports immediately after the bus resetting, but, the number of undefined ports checked in the step S204 varies with the proceeding of determination of the parent-child relationship. Immediately after the bus resetting, the declaration of the parent-child relationship can be started only from a leaf. Being a leaf can be known from the confirmation of the number of ports in the step S203. In a step S205, the leaf declares, to a node connected thereto, that “the leaf itself is a child and the partner is a parent”.

In a node having plural ports in the step S203 and recognized as a branch, the step S204 identifies that the number of the undefined ports>1 immediately after the bus resetting, so that the sequence proceeds to a step S206 in which the node is given a branch flag. Then in a step S207 it waits to receive the position as parent in the parent-child declaration from a leaf. The branch receiving the parent-child relationship declaration of the leaf in the step S207 confirms the number of the undefined ports checked in the step S204, and, if the number of the undefined ports has become 1, it can declare that “it is a child” in the step S205 to the node connected to the remaining port. The branch having two or more undefined ports in the step S204 in the second or subsequent cycle waits to receive the position as parent from a leaf or another branch in the step S207.

The declarations of the parent-child relationship is completed in the entire network when the number of the undefined ports checked in the step S204 becomes eventually zero in a branch or exceptionally a leaf (because of a belated declaration of being a child), and the unique node having zero undefined port (being determined as the port of all the parents) is given a root flag in a step S208 and is recognized as a root in a step S209. Thus, in the flow charts shown in FIGS. 18 and 19, there is completed the procedure from the bus resetting to the declarations of the parent-child relationship among all the nodes in the network.

In the following there will be explained the flow charts shown in FIGS. 20 to 22. The flag information of the nodes, indicating leaves, branches and root and determined in the sequence shown in FIGS. 18 and 19, are classified in a step S301. In giving ID to the nodes, the ID setting can be initiated from a leaf. The ID setting is executed in the order of leaves, then branches and root, and in the increasing order of the node number starting from 0.

A step S302 sets the number N (being a natural number) of the leaves present in the network. Then, in a step S303, each leaf request an ID to the root. In case of plural requests, the root executes an arbitration in a step S304, and, in a step S305 gives ID to a winning node and informs the losing nodes of the losing results. In a step S306, the leaf having failed to acquire ID issues the request for ID again, and the sequence is similarly repeated.

In a step S307, the leaf having acquired ID transfers the ID information to all the nodes by broadcasting (communication from a node to unspecified plural nodes on the network). After the broadcasting of the ID information of a node, a step S308 decreases the number of the remaining leaves by one. If a step S309 identifies that at least one leaf remains, the sequence starting from the ID request in the step S303 is repeated. When all the leaves have finally broadcast the ID information, the step S309 identifies N=0, whereupon the ID setting shifts to branches.

The ID setting for the branches is executed in a similar manner as in the case of leaves. At first a step S310 sets the number M (being a natural number) of the branches present in the network. Then, in a step S311, each branch requests an ID to the root. In response, the root executes an arbitration in a step S312, and gives an ID number, next to the numbers already given to the leaves, to a winning node. In a step S313, the root informs the requesting branches with the ID information or the losing results, and, in a step S314, the branch having failed to acquire ID issues the request for ID again, and the sequence is similarly repeated.

In a step S315, the branch having acquired ID transfers the ID information to all the nodes by broadcasting. After the broadcasting of the ID information of a node, a step S316 decreases the number of the remaining branches by one. If a step S317 identifies that at least one branch remains, the sequence starting from the ID request in the step S311 is repeated. When all the branches have finally acquired the ID information, the step S317 identifies M=0, whereupon the ID acquisition mode for the branches is terminated.

In this state, the root only has not acquired the ID information. Thus, in a step S318, the root sets the smallest ungiven number as its own ID number, and a step S319 broadcasts the ID information of the root. Thus, in the flow charts shown in FIGS. 20 to 22, there is completed the procedure after the determination of the parent-child relationship to the ID setting for all the nodes.

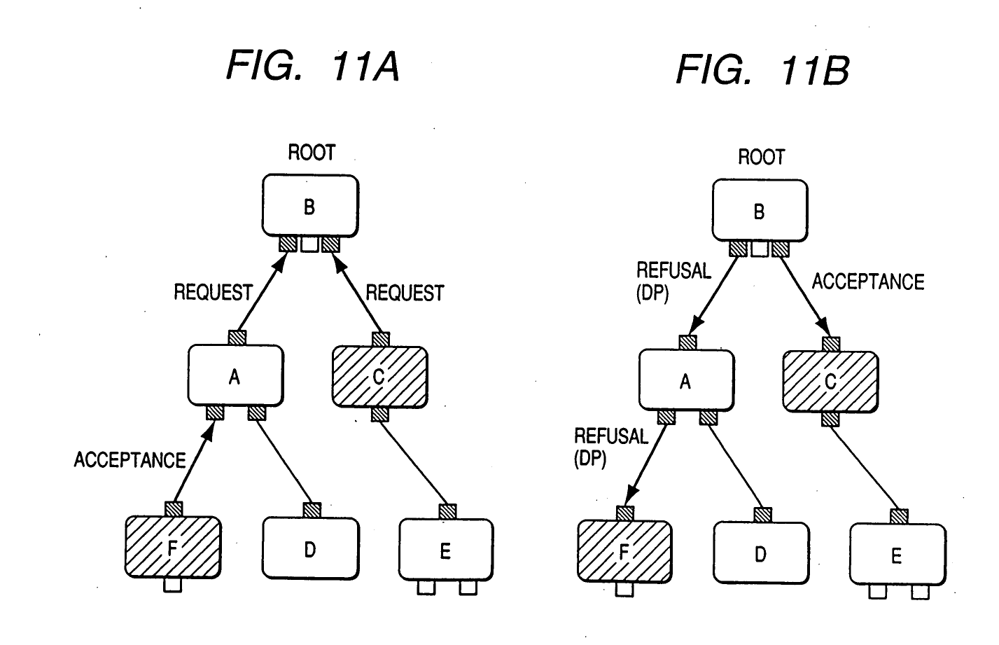

In the following there will be explained, as an example, the operations in an actual network shown in FIG. 10. FIG. 10 shows a hierarchic structure in which nodes A and C are directly connected under a root node B, while a node D is directly connected under the node C, and nodes E, F are connected under the node D. In the following there will be given an explanation on such hierarchic structure and the procedure of determining the root node and the node ID's. After bus resetting, there is executed the declaration of the parent-child relationship between the directly connected ports of the nodes, in order to recognize the connection status of the nodes. In the parent-child relationship, the parent side assumes a higher position and the child side assumes a lower position in the hierarchic structure.

After the bus resetting in the configuration of FIG. 10, the parent-child declaration is at first executed by the node A. Basically, the parent-child declaration can be started from a node having connection only at a port thereof (such node being called a leaf). Such node can identify that it has the connection at one port only and can therefore known that it constitutes an end of the network, and the parent-child relationship is determined from a fast reacting one among such leaves. Thus the port of the side declaring the parent-child relationship (namely node A in the connection A-B) is set as a child, and the port of the partner (node B) is set as a parent. Thus in the connections A-B, E-D and F-D there are respectively determined a child and a parent.

Then the procedure shifts to an upper level, and the parent-child relationship declaration to an further higher level starting from the nodes, among those having port with plural connections (such node being called a branch), having received the parent-child declaration from other nodes. In FIG. 10, the node D, after the determination of the parent-child relationship in D-E and D-F, declares the parent-child relationship to the node, whereby the nodes D, C are respectively determined as a child and a parent in the connection D-C. The node C, having received the parent-child declaration from the node D, declares the parent-child relationship to the node B connected to another port, whereby the nodes C, B are respectively determined as a child and a parent in the connection C-B. As a result the hierarchic structure shown in FIG. 10 is determined, and the node B finally becoming the parent in all the connected ports is determined as the root node. There exists only one root within a network configuration.

In the configuration shown in FIG. 10 the node B is determined as the root node, but the root node may shift to another node if the node B, having received the parent-child declaration from the node A, executes the parent-child declaration to another node at an earlier timing. Thus depending on the timing of declaration, any node may become the root node, and the root node is not fixed in a given network configuration.

After the determination of the root node, there is entered the mode of determining the node ID. Each of all the nodes informs all other nodes of the determined self ID (broadcasting function). The self ID information contains the self node number, information on the connecting position, number of ports, number of connected ports, information on the parent-child relationship of each port etc. The node ID assignment can be initiated from the nodes having connection only at a port (namely leaves), and the node numbers are assigned in the order of 0, 1, 2, . . . among such leaves. The node having acquired the node ID transmits the information including the node number to other nodes by broadcasting. Thus such ID number is recognized as “already assigned”.

When all the leaves have acquired the self node ID's, ID numbers succeeding to those assigned to the leaves are then assigned to the branch nodes. As in the case of leaf, branches having acquired the node ID number broadcast the node ID information in succession, and the root node at last broadcasts the self ID information. Consequently the root node always has the largest node ID number. In this manner the node ID assignment is completed for the entire hierarchic structure, whereby the network configuration is reconstructed and the bus initialization is completed.

[Arbitration]

In the 1394 serial bus, an arbitration for the bus use right is always executed prior to the data transfer. The 1394 serial bus is a logic bus-type network in which the same signal is transmitted to all the equipment in the network by the relaying function of each connected equipment, the arbitration is indispensable for avoiding packet collision. Through such arbitration, only one node can execute transfer at a given time.

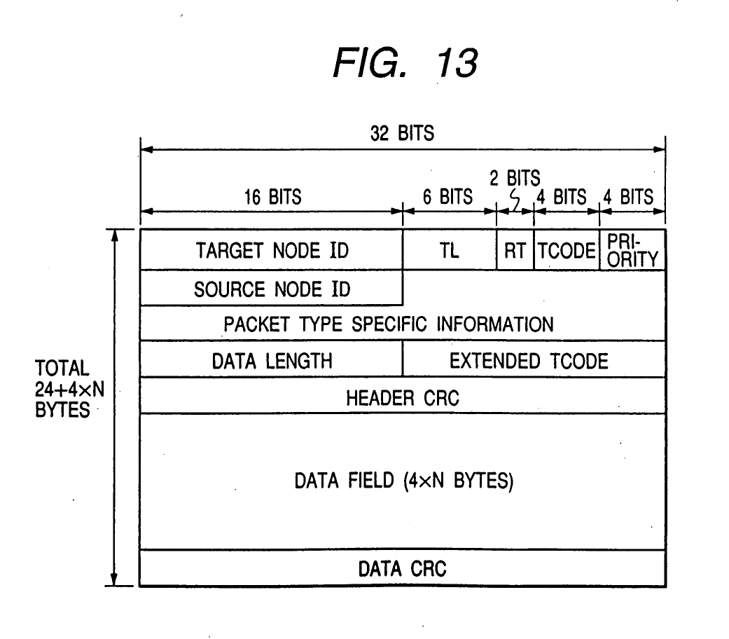

The arbitration procedure will be explained with reference to FIG. 11A showing the operation of requesting the bus use right and FIG. 11B showing the operation of permitting the bus use right. When the arbitration is initiated, a node or each of plural nodes issues a request for the bus use right to the parent node. In FIG. 11A, the nodes C and F issue the requests. In response, the parent node (node A in FIGS. 11A and 11B) issues (or relays) the request for the bus use right to a parent node. The request is finally delivered to the arbitrating root.

Receiving the request for the bus use right, the root node determines the node by which the bus is to be used. The arbitrating operation is executed only by the root node, and the permission to use the bus is given to the winning node in the arbitration. FIG. 11B shows a state in which the permission is given to the node C while the use by the node F is refused. A DP (data prefix) packet is transmitted to the losing node, indicating the refusal of the request. The request for the bus use right from the refused node has to wait until the next arbitration. The node having won the arbitration and acquired the permission for using the bus can thereafter start the data transfer.

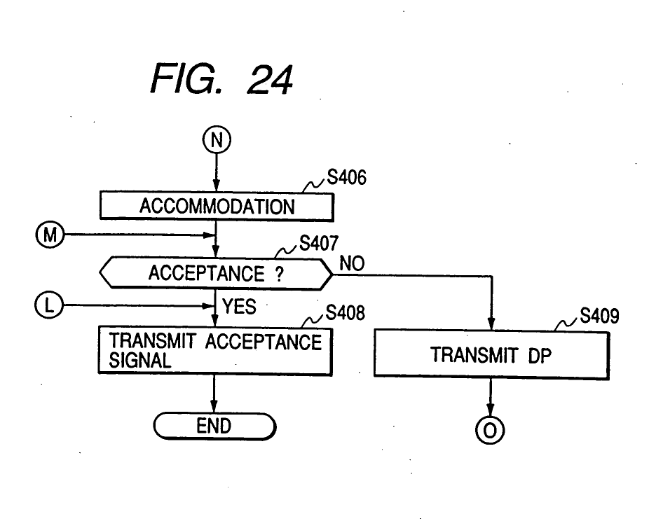

The flow of the arbitration will be explained with reference to flow charts shown in FIGS. 23 and 24. In order that the node can initiate the data transfer, the bus has to be in the idle state. In order to recognize that the bus is currently empty after the completion of the preceding data transfer, there is predetermined an idle time gap length (for example subaction gap) for each transfer mode, and each node judges that it can start its transfer after the lapse of such time gap.

A step S401 discriminates whether a predetermined gap length is obtained corresponding to the data to be transferred such as the async data or iso data. The sequence waits until the predetermined gap length is obtained, since the bus use right required for starting the data transfer cannot requested unless such gap length is obtained. The predetermined gap length is obtained in the step S401, a step S402 discriminates whether data to be transferred are present, and, if present, a step S403 issues a request for the bus use right for securing the bus to the root. The signal representing the request for the bus use right is transmitted through the nodes in the network as shown in FIG. 11A and eventually delivered to the root. If the step S402 identifies absence of data, the sequence remains in the waiting state.

Then, if the root receives in a step S404 at least a request for the bus use right issued in the step S403, the root checks in a step S405 the number of the nodes having issued the request. If the step S405 identifies that the node number=1 (request issued from only one node), the permission to use the bus is to be given to such node immediately thereafter. If the step S405 identifies the node number>1 (requests issued from plural nodes), the root executes in a step S406 an arbitration for selecting one node for giving the permission. This arbitration is conducted in such fair manner that the permissions are not given to a particular node but uniformly given to all the nodes.

Then, in a step S407, the root classifies, among the plural nodes having issued the request in the step S403, a winning node that has acquired the permission by the arbitration and other losing nodes. In a step S408, the root sends a permission signal to the single node that has acquired the permission as the result of the arbitration or without the arbitration in case the node number=1 in the step S405, and the node having received the permission signal immediately initiates the transfer of the data (packet) to be transferred. The root also sends, in a step S409, the aforementioned DP packet indicating the loss in the arbitration to the node which has failed to acquire the permission in the arbitration in the step S406. The node which has received the DP packet returns to the step S401 in order to issue again the request for the bus use right for data transfer, and waits until the predetermined gap length is obtained.

[Asynchronous (Non-sync) Transfer]

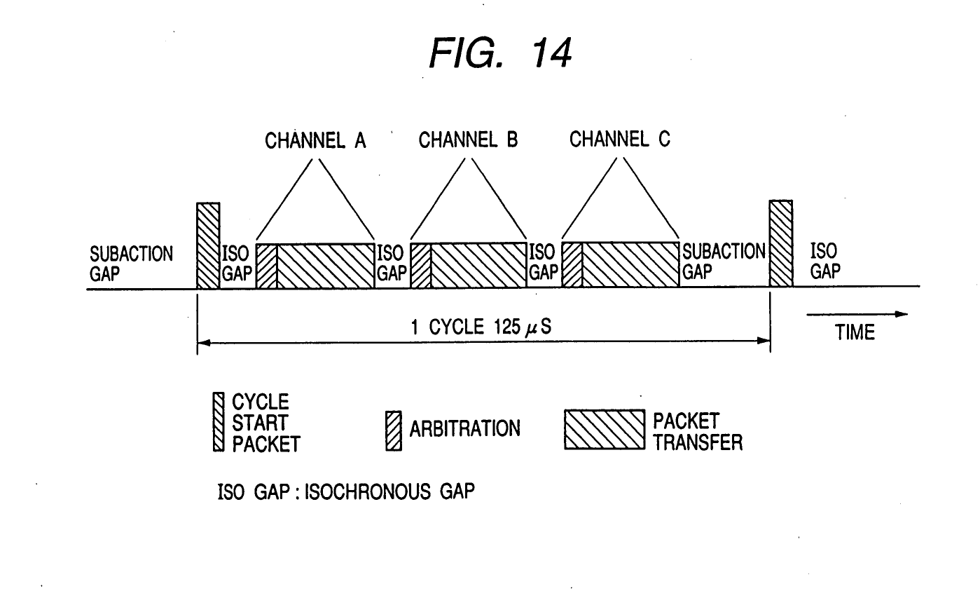

The asynchronous transfer is a non-synchronized transfer. FIG. 12 shows phases in time of the asynchronous transfer, in which the initial subaction gap indicates the idle state of the bus. When this idle time reaches a predetermined value, the node wishing the data transfer judges that the bus is available and enters the arbitration process for acquiring the bus use right.

When the bus use right is acquired in the arbitration, the data transfer is executed in a packet format. After the data transfer, the receiving node completes the transfer by returning an acknowledgement code “ack” indicating the result of reception or sending a response packet, after a short gap called “ack gap”. The “ack” code consists of 4-bit information and 4 check sum bits, including information indicating whether the transfer is successful or pending or the line is busy, and is immediately returned to the transmitting node.

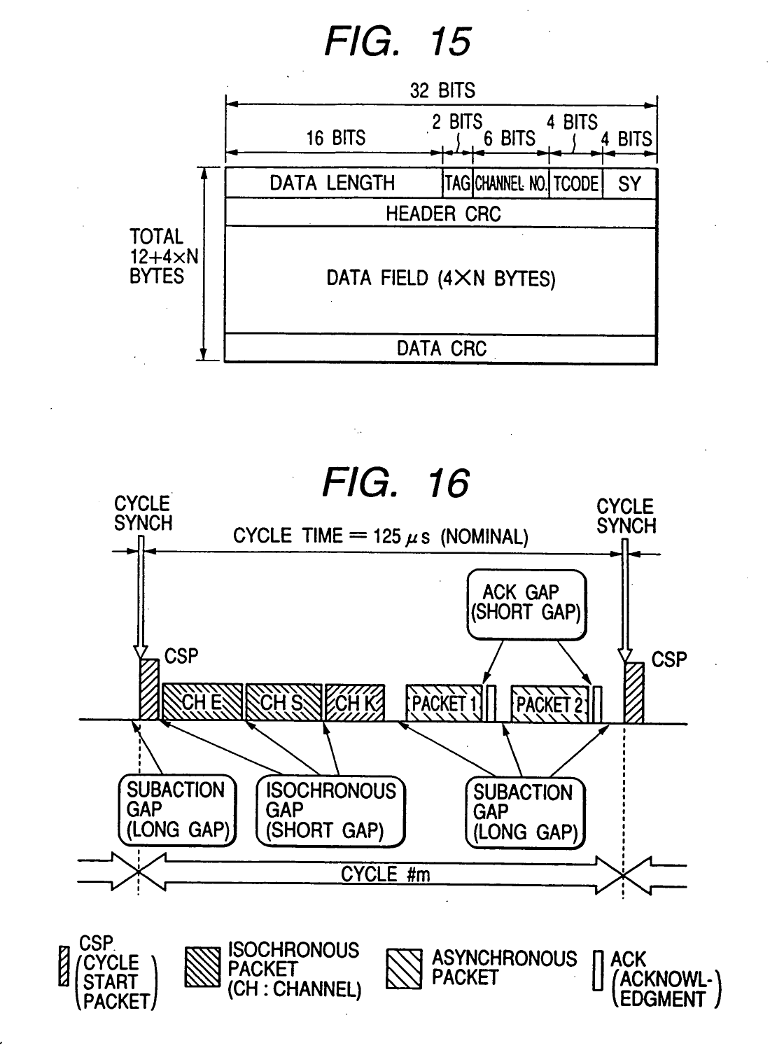

FIG. 13 shows an example of the packet format for the asynchronous transfer. The packet consists of a data portion, CRC (cyclic redundancy check) data for error correction and a header, which contains, as shown in FIG. 13, a destination node ID, a source node ID, a transfer data length and various codes. The asynchronous transfer is a 1-to-1 communication from the source node to the destination node. The packet transferred from the source node is delivered to all the nodes in the network, but is disregarded in the nodes different in address and is read by the only one node of the address.

[Isochronous (Sync) Transfer]

The isochronous transfer is a synchronized transfer. The isochronous transfer, constituting the most important feature of the 1394 serial bus, is particularly suitable for transfer of the data requiring real-time transfer, for example multi-media data such as video image data or audio data. In contrast to the asynchronous transfer in the 1-to-1 form, the isochronous transfer is conducted from the transferring source node to all other nodes uniformly by the broadcasting function.

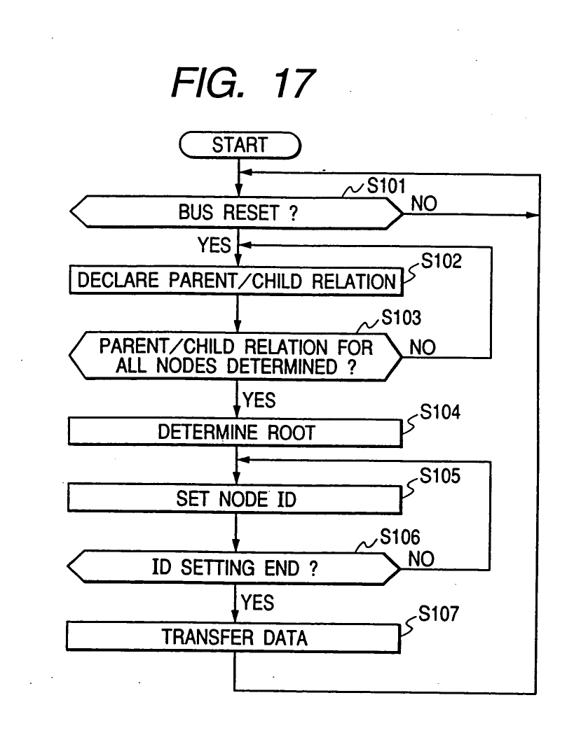

FIG. 14 shows phases in time of the isochronous transfer. The isochronous transfer is executed on the bus at a constant interval, which is called the isochronous cycle and is selected as 125 μs. A cycle start packet indicates the start time of the isochronous cycle, thus adjusting the time in each node. The cycle start packet is transmitted by a node called cycle master, which transmits the cycle start packet indicating the start of a cycle, after the lapse of a predetermined idle time (subaction gap) following the end of transfer in the immediately preceding cycle. Thus the cycle start packets are transmitted with an interval of 125 μs.

As indicated by channels A, B and C in FIG. 14, the packets of plural kinds within a cycle are respectively given channel ID's and can be distinguished in the transfer. Consequently the real-time simultaneous transfers among plural nodes are made possible, and the receiving node fetches the data of a desired channel ID only. The channel ID does not indicate the address of the destination but merely gives a logic number to the transferred data. Consequently any packet is transmitted by broadcasting from a source node to all other nodes.

Prior to the isochronous packet transfer, there is executed an arbitration as in the case of asynchronous transfer. However, in the isochronous transfer, which is not the 1-to-1 transfer, there is no acknowledgement code. The isochronous gap (iso gap) shown in FIG. 14 indicates an idle time required for confirming the availability of the bus, prior to the start of the isochronous transfer. When this idle time lapses, the node wishing the isochronous transfer judges that the bus is available and can enter the arbitration prior to the data transfer.

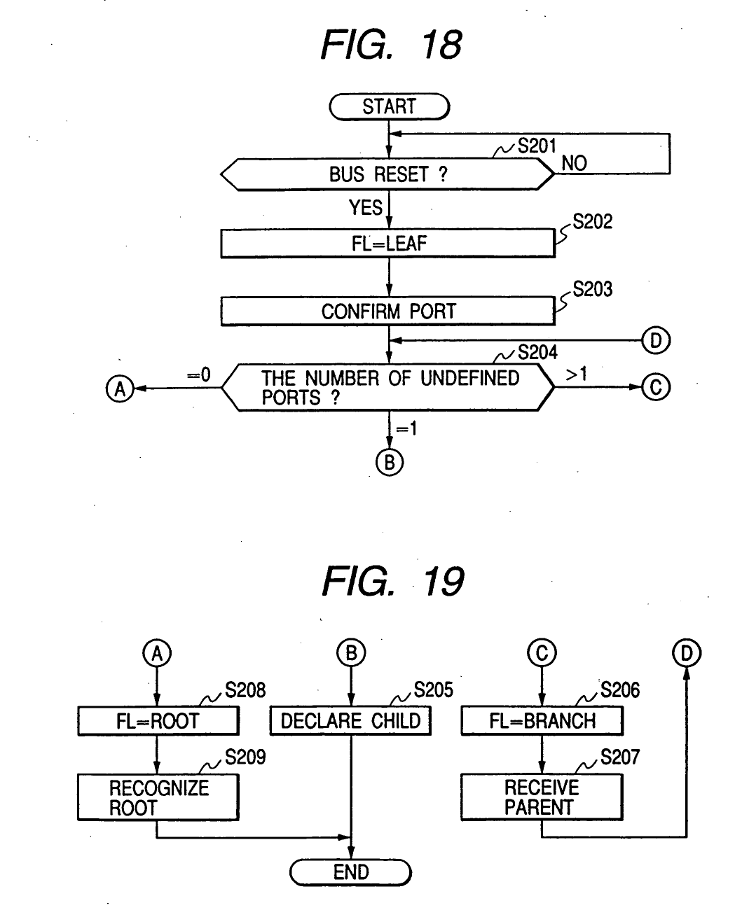

FIG. 15 shows an example of the packet format for the isochronous transfer. The packet divided in each channel consists of a data portion, CRC (cyclic redundancy check) data for error correction and a header, which contains, as shown in FIG. 15, a transfer data length, a channel number, various codes and an error correcting CRC data.

[Bus Cycle]

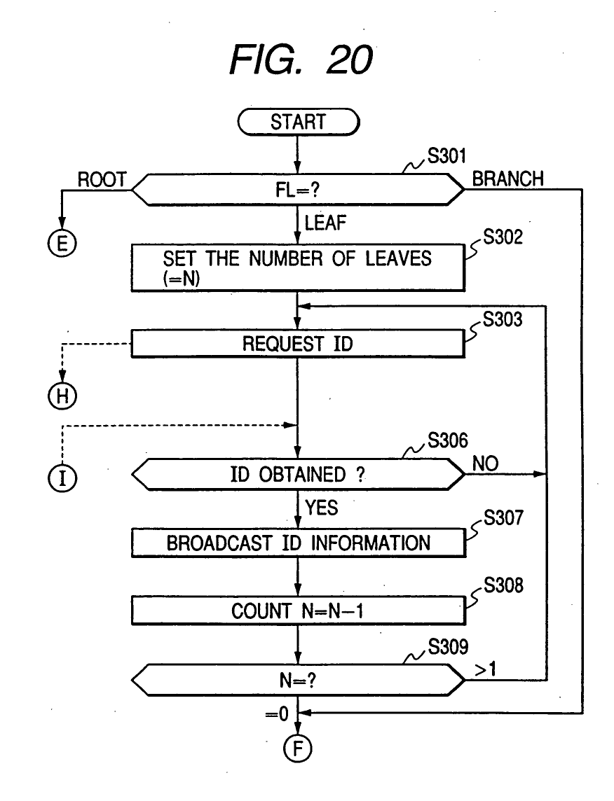

On the actual 1394 serial bus, the asynchronous transfer and the isochronous transfer can be present in mixed manner. FIG. 16 shows phases in time of the transfer state on the bus wherein the asynchronous transfer and the isochronous transfer are present in mixed manner. The isochronous transfer has the higher priority than the asynchronous transfer, because, after the cycle start packet, the isochronous transfer can be activated with a shorter gap length (isochronous gap) of the idle period than the gap length (subaction gap) required for activating the asynchronous transfer. Therefore the isochronous transfer is executed preferentially to the asynchronous transfer.

In a general bus cycle shown in FIG. 16, the cycle start packet is transferred from the cycle master to other nodes at the start of a cycle #m. In response each node executes time adjustment, then the node wishing the isochronous transfer enters arbitration after waiting for the predetermined idle period (isochronous gap) and then transfers the packet. In FIG. 16, the isochronous transfer is executed in succession in the channels e, s and k. The sequence from the arbitration to the packet transfer is repeated for the number of assigned channels to complete the isochronous transfer in the cycle #m, and the asynchronous transfer is then enabled.

When the idle time reaches the subaction gap required for the asynchronous transfer, the node wishing the asynchronous transfer judges that it can enter the arbitration. However, the asynchronous transfer is enabled only if the subaction gap required for activating the asynchronous transfer can be realized within the period from the end of the isochronous transfer to the time (cycle synch) for transferring the next cycle start packet.

The cycle #m shown in FIG. 16 executes isochronous transfer of 3 channels and asynchronous transfer of 2 packets (packets 1 and 2) including the acknowledgements. The cycle #m ends after the asynchronous packet 2 because there is reached the time (cycle synch) for starting the cycle #m+1. However, if the time (cycle synch) for starting the next cycle is reached in the course of an isochronous or asynchronous transfer, such transfer is not interrupted but the cycle start packet of the next cycle is transmitted in the idle time after the end of such transfer. Thus, if a cycle continues in excess of 125 μs, the next cycle is made correspondingly shorter than 125 μs. In this manner the isochronous cycle can be made longer or shorter, taking 125 μs as the standard.

However, the isochronous transfer, if requested, is always executed in every cycle in order to maintain the real-time transfer, while the asynchronous transfer may be delayed to the next or subsequent cycle in case the cycle time is shortened. The cycle time, including information on such delay, is managed by the cycle master. In the foregoing, there has been summarized the functions of the IEEE 1394 serial bus.

As an encoding method adapted for transmission at 64 Kbps (bit per second) adopted as the basic interface of the Integrated Services Digital Network (ISDN), there is proposed the CCITT (Committee consultative international telegraphique et telephonique) Recommendation H.261, which is the encoding method for moving image transmission by ISDN for television conference/telephone.

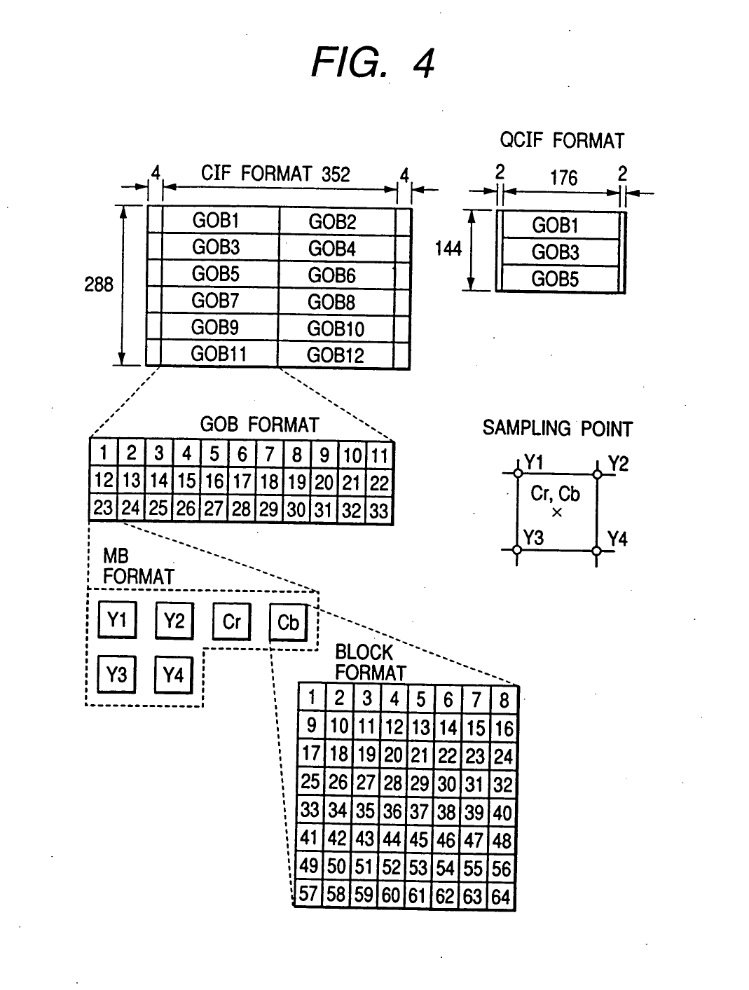

The H.261 recommendation defines common video formats in order to enable communication among plural standards such as the NTSC (National Television System Committee) standard, the PAL (Phase Alternation by Line) standard adopted in Europe and China, and the digital television signals. FIG. 4 shows the configuration of such formats: which are CIF (Common Intermediate Format: an intermediate format for conversion into a different television standard or a broadcasting format of different transfer rate) and QCIF format.

The CIF format has a sample number of 352 pixels×288 lines in the luminance signal Y, and 176 pixels×144 lines in the color difference signals Cr, Cb. The sample point for the color difference signals (Cr, Cb) is defined at an equal distance from the four luminance points (Y1, Y2, Y3, Y4). The QCIF format has an information amount equal to ¼ of that of the CIF format, and has a sample number of 176 pixels×144 lines for the luminance signal Y and 88 pixels×72 lines for the color difference signals Cr, Cb. The CIF format is composed of 12 GOB (group of blocks), and a GOB is composed of 32 MB (macroblocks) each of which is composed of 4 luminance blocks Y1, Y2, Y3, Y4 each having 8 pixels×8 lines and of 2 color difference blocks Cr, Cb each having 8 pixels×8 lines. The above-mentioned hierarchic structure enables encoding in the unit of MB.

Thus the GOB has a sample number of 176 pixels×48 lines for the luminance signal Y and 88 pixels×24 lines for the color difference signals Cr, Cb, corresponding to 1/12 of the CIF format and ⅓ of the QCIF format. The GOB's are numbered as GOB1 to GOB12 in the CIF format and as GOB1, GOB3, GOB5 in the QCIF format.

For achieving image compression or image encoding, there are utilized an intraframe encoding of dividing the image of a frame into blocks of 8×8 pixels and applying two-dimensional discrete cosine transformation (DCT) for such blocks, an interframe encoding of calculating the difference between a preceding frame and a current frame in the blocks of a same position therebetween and applying the two-dimensional DCT on the difference, a movement compensation of reducing the code amount by compensating the image movement between the frames, a zero run length encoding utilizing a fact that zero values generally continues in the DCT coefficients of the high frequency region, a quantization varying the quantization step size according to the data generation amount, a variable length encoding of assigning shorter codes to the data patterns of higher frequencies of generation and longer codes to the data patterns of lower frequencies of generation, and a frame skipping, and a high compression ratio is achieved by the combination of these technologies to enable transmission of a moving image in the communication channel of a low transfer rate.

The interframe encoding mode (INTER mode) is adopted in case the correlation exceeding a certain level exists between the frames since a high compression rate can be achieved in case of a high correlation between the frames, while the intraframe encoding mode (INTRA mode) is adopted in case the interframe correlation is less than the above-mentioned level. In the INTER mode, the quantization error, resulting from the difference between the quantization at the transmitting side and that at the receiving side, is accumulated at the receiving terminal and becomes conspicuous if the quantization levels are coarse. It is therefore common to arrange the INTRA mode periodically. The INTRA mode is provided periodically in the unit of the above-mentioned block, in order also to prevent propagation of the transmission error.

In particular, all the blocks in a frame are intraframe encoded in case the reference image for difference calculation is not available for example at the start of image communication or in case of a scene change showing no interframe correlation over the entire image, and such process is called an all INTRA process. Such process allows to refresh the image, eliminating the decoding error and the quantization error.

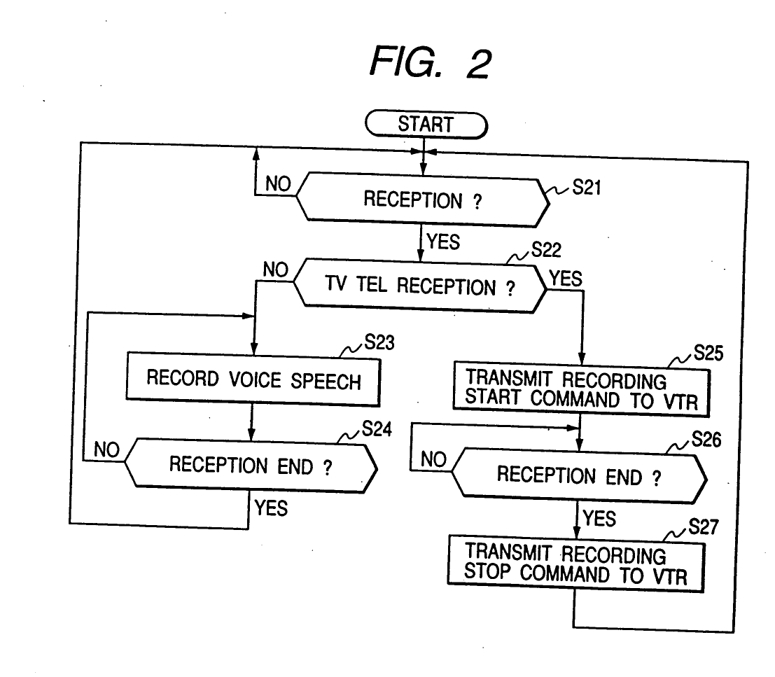

In the following there will be explained, with reference to a flow chart in FIG. 2, the functions of the message telephone/VTR system of the first embodiment of the present invention.

The system control unit 13 of the message telephone 31 of the message telephone/VTR system discriminates the presence of a reception from the public line 1 (step S21). In the presence of a reception from the public line 1, the system control unit 13 discriminates whether it is the reception from a TV telephone (step S22). If not, the audio data entered through the line I/F 2 and the separation/multiplexing unit 3 are decoded by the audio decoding unit 7 into an analog audio signal and the audio communication is recorded by the audio recording unit 27, whereby the function of the ordinary message telephone is achieved (steps S23, S24).

If the step S22 identifies a reception from the TV telephone, the system control unit 13 fetches audio data and image data through the line I/F 2 and the separation/multiplexing unit 3. The image data are decoded by the image decoding unit 4 and the image I/F 5 and encoded again into digital data by the image encoding unit 6. Also the audio data and the image data are decoded by the decoding unit 10, then are formed into packet data of the above-described 1394 serial bus communication by the packet data generation unit 11 and the memory 12 and are outputted to the VTR 32 by the 1394 I/F 16.

The system control unit 13 of the message telephone 31 also executes control for transmitting a recording start command, in a form attached in the packet data generation unit 11 to the audio/image signals. The system control unit 24 of the VTR 32 of the message telephone/VTR system, upon receiving the recording start command from the message telephone 31 through the 1394 I/F 17 and the data selector 18, controls the data selector 18 so as to send the audio/image signals to the signal processing unit 19 and also controls the signal processing unit 19 so as to effect signal processing for signal recording on a magnetic tape by the head amplifier 20 and the head unit 21, whereby the audio/image signals are recorded by the head unit 21 on the magnetic tape (step S25).

On the other hand, the system control unit 13 of the message telephone 31 discriminates, by the line I/F 2, whether the reception from the TV telephone has been completed (step S26). If completed, the system control unit 13 controls the packet data generation unit 11 so as to transmit a recording stop command to the 1394 serial bus, whereby the recording stop command is transmitted by the 1394 I/F 16 to the VTR 32. The system control unit 24 of the VTR 32, upon receiving the recording stop command through the 1394 I/F 17 and the data selector 18, controls the signal processing unit 19 so as to terminate the recording on the magnetic tape by the head amplifier 20 and the head unit 21, thereby terminating the recording by the head unit 21 (step S27).

In the message telephone/VTR system of the first embodiment of the present invention, as explained in the foregoing, the message telephone 31 is provided with the system control unit 13 for discriminating the presence of the reception of a TV telephone call from the public line 1 and, in case of presence of such reception, for transmitting the packet data generated by decoding the audio/image data and the recording start/stop command to the VTR 32 through the 1394 I/F 16, while the VTR 32 of the system is provided with the system control unit 24 for controlling the start and stop of the recording based on the packet data and the recording start/stop command transmitted from the system control unit 13, whereby achieved are the following functions and effects.

In the above-described configuration, the system control unit 13 of the message telephone 31 executes such control, in case the received signals are identified as from the TV telephone, as to transmit the digital audio/image signals and the recording start command to the VTR 32 through the 1394 I/F 16 thereby causing the head unit 21 of the VTR 32 to effect recording on the magnetic tape. Also the system control unit 13 of the message telephone 31 executes such control, in case the reception from the TV telephone is identified as having been completed, as to transmit the recording stop command to the VTR 32 through the 1394 I/F 16, thereby terminating the function of the VTR 32.

Consequently, in the first embodiment of the present invention, the VTR is utilized for recording the image signal such as the signal of a TV telephone, so that the message recording for the TV telephone can be realized even if the telephone unit itself does not have the ability of recording the image signal. Also the use of the IEEE 1394 serial bus allows to realize such function merely by connection of the IEEE 1394 cables.

### [2] Second Embodiment

The message telephone/VTR system constituting the second embodiment of the present invention is principally composed, as in the first embodiment, of a message telephone 31 and a VTR 32. The message telephone 31 is provided with a line I/F 2, a separation/multiplexing unit 3, an image decoding unit 4, an image I/F 5, an image encoding unit 6, an audio decoding unit 7, an audio I/F 8, an audio encoding unit 9, a decoding unit 10, a packet data generation unit 11, a memory 12, a system control unit 13, a display unit 14, an operation unit 15, a 1394 I/F 16, and an audio memory unit 27. Also the VTR 32 is provided with a 1394 I/F 17, a data selector 18, a signal process unit 19, a head amplifier 20, a head unit 21, a D/A converter 22, an external output unit 23, a system control unit 24, an operation unit 25 and a display unit 26 (cf. FIG. 1). The configuration of each unit has been explained in detail in the first embodiment and will not be explained further.

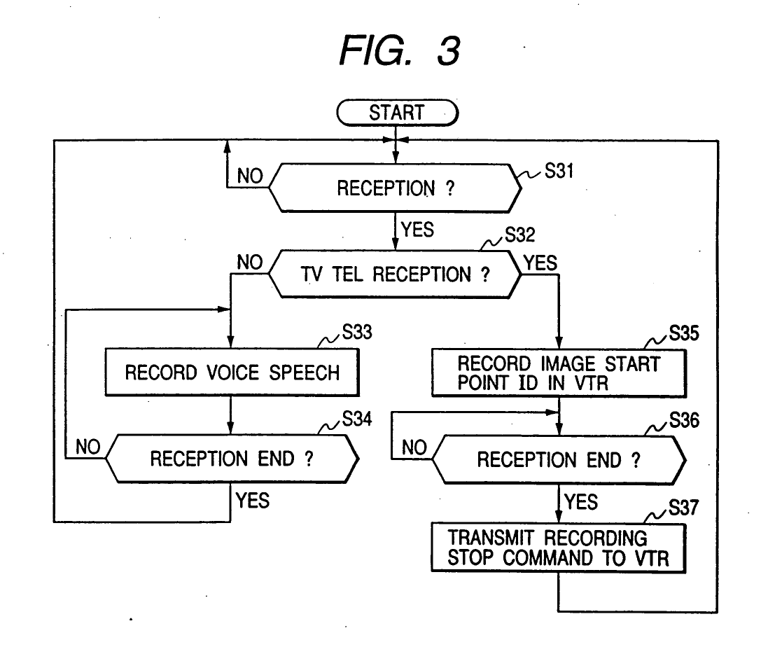

In the following there will be explained, with reference to a flow chart in FIG. 3, the functions of the message telephone/VTR system of the second embodiment of the present invention.

The system control unit 13 of the message telephone 31 of the message telephone/VTR system discriminates the presence of a reception from the public line 1 (step S31). In the presence of a reception from the public line 1, the system control unit 13 discriminates whether it is the reception from a TV telephone (step S32). If not, the audio data entered through the line I/F 2 and the separation/multiplexing unit 3 are decoded by the audio decoding unit 7 into an analog audio signal and the audio communication is recorded by the audio recording unit 27, whereby the function of the ordinary message telephone is achieved (steps S33, S34).

If the step S32 identifies a reception from the TV telephone, the system control unit 13 fetches audio data and image data through the line I/F 2 and the separation/multiplexing unit 3. The image data are decoded by the image decoding unit 4 and the image I/F 5 and encoded again into digital data by the image encoding unit 6. Also the audio data and the image data are decoded by the decoding unit 10, then are formed into packet data of the above-described 1394 serial bus communication by the packet data generation unit 11 and the memory 12 and are outputted to the VTR 32 by the 1394 I/F 16.

The system control unit 13 of the message telephone 31 also executes control for transmitting a command, for entering ID for informing the recording start position, in a form attached in the packet data generation unit 11 to the audio/image signals. The system control unit 24 of the VTR 32 of the message telephone/VTR system, upon receiving the recording start command from the message telephone 31 through the 1394 I/F 17 and the data selector 18, controls the data selector 18 so as to send the audio/image signals to the signal processing unit 19 and also controls the signal processing unit 19 so as to effect signal processing for signal recording on a magnetic tape by the head amplifier 20 and the head unit 21, whereby the audio/image signals and the ID indicating the start position are recorded by the head unit 21 on the magnetic tape (step S35).

On the other hand, the system control unit 13 of the message telephone 31 discriminates, by the line I/F 2, whether the reception from the TV telephone has been completed (step S36). If completed, the system control unit 13 controls the packet data generation unit 11 so as to transmit a recording stop command to the 1394 serial bus, whereby the recording stop command is transmitted by the 1394 I/F 16 to the VTR 32. The system control unit 24 of the VTR 32, upon receiving the recording stop command through the 1394 I/F 17 and the data selector 18, controls the signal processing unit 19 so as to terminate the recording on the magnetic tape by the head amplifier 20 and the head unit 21, thereby terminating the recording by the head unit 21 (step S37).

Also in reproducing the recorded message, in case of reproducing the signal of the TV telephone, the system control unit 13 of the message telephone 31, in response to a predetermined operation of the user on the operation unit 15, executes such control as to transmit a command for searching the recording start point and effect reproduction through the 1394 serial bus, whereby the above-mentioned command is transmitted to the VTR 32 through the packet data generation unit 11 and the 1394 I/F 16. The system control unit 24 of the VTR 32, upon receiving the above-mentioned command through the 1394 I/F 17 and the data selector 18, executes such control as to cause the head amplifier 20 and the head unit 21 to search the recording start point, whereby the reproduction is executed by the head unit 21.

In the message telephone/VTR system of the second embodiment of the present invention, as explained in the foregoing, the message telephone 31 is provided with the system control unit 13 for discriminating the presence of the reception of a TV telephone call from the public line 1 and, in case of presence of such reception, for transmitting the packet data generated by decoding the audio/image data and the recording start/recording stop/reproduction command, for starting the recording and providing ID indicating the recording start point, to the VTR 32 through the 1394 I/F 16, while the VTR 32 of the system is provided with the system control unit 24 for controlling the start/stop of recording and reproduction based on the packet data and the recording start/recording stop/reproduction command transmitted from the system control unit 13, whereby achieved are the following functions and effects.

In the above-described configuration, the system control unit 13 of the message telephone 31 executes such control, in case the received signals are identified as from the TV telephone, as to transmit the digital audio/image signals and the command for starting the recording and recording ID indicating the recording start point to the VTR 32 through the 1394 I/F 16 thereby causing the head unit 21 of the VTR 32 to effect recording on the magnetic tape. Also the system control unit 13 of the message telephone 31 executes such control, in case the reception from the TV telephone is identified as having been completed, as to transmit the recording stop command to the VTR 32 through the 1394 I/F 16, thereby terminating the function of the VTR 32. Also in reproducing the recorded message, in case of reproducing the signal of the TV telephone, the system control unit 24 of the VTR 32, upon receiving the command from the system control unit 13 of the message telephone 31, searches the recording start point and executes reproduction.

Consequently, also in the 2nd embodiment of the present invention, the VTR is utilized as in the first embodiment for recording the image signal such as the signal of a TV telephone, so that the message recording for the TV telephone can be realized even if the telephone unit itself does not have the ability of recording the image signal. Also the use of the IEEE 1394 serial bus allows to realize such function merely by connection of the IEEE 1394 cables.

In the foregoing first and second embodiments of the present invention, a VTR has been explained as the apparatus for recording the image signal, but the present invention is not limited to the VTR, and for example an HDD (hard disk drive) or other magnetic recording devices may be employed as the recording apparatus. Also in such case the aforementioned recording of the image signal can be achieved by operations similar to those in the foregoing first and second embodiments.

The present invention may also be applied to a system consisting of plural equipments or an apparatus consisting of a single equipment (such as a copying machine or a facsimile apparatus). Also the objects of the present invention can naturally be attained in a case where a memory medium storing the program codes of a software realizing the functions of the aforementioned embodiments is supplied to a system or an apparatus and the functions of the aforementioned embodiments are realized by a computer (CPU or MPU) of the above-mentioned system or apparatus by reading and executing the program codes stored in the memory medium.

In such case the program codes themselves read from the memory medium realize the functions of the aforementioned embodiments, and the memory medium storing the program codes constitutes the present invention.

The memory medium storing such program codes can be, for example, a floppy disk, a hard disk, an optical disk, a magnetooptical disk, a CD-ROM, a CD-R, a magnetic tape, a non-volatile memory card or a ROM.

The present invention also includes not only a case where the functions of the aforementioned embodiments are realized by the execution of the read program codes by the computer but also a case where an operating system or the like functioning on the computer executes all or a part of the actual processes under the control of such program codes thereby realizing the functions of the foregoing embodiments.

The present invention further includes a case wherein the program codes read from the memory medium are once stored in a memory provided in a function expansion board inserted into the computer or a function expansion unit connected to the computer, and a CPU provided in the function expansion board or the function expansion unit executes all the process or a part thereof according to the instructions of such program codes, thereby realizing the functions of the aforementioned embodiments.

As explained in the foregoing, the communication apparatus or method of the foregoing embodiments, capable of receiving the communication information from the outside, is provided with discrimination means for discriminating the presence or absence of reception of the communication information, and control means for enabling a recording apparatus capable of recording the communication information in case of reception thereof, thereby attaining following effects. In case of reception of the communication information, the recording apparatus capable of recording the communication information is enabled for recording, whereby such recording apparatus can be utilized for recording the image signal such as the signal of the TV telephone and the message recording for the TV telephone can be realized even if the communication apparatus itself is not provided with the function of recording the image signal.

Also the discrimination means has a function of discriminating whether the communication information is an image signal, while the control means has a function, in case the communication information is identified as an image signal, of causing the recording apparatus to start recording, so that the following effect can be attained. In case of reception of an image signal as the communication information, the recording apparatus capable of recording the communication information is caused to start recording, whereby such recording apparatus can be utilized for recording the image signal such as the signal of the TV telephone and the message recording for the TV telephone can be realized even if the communication apparatus itself is not provided with the function of recording the image signal.

Also the control means executes such control, in case the communication information is identified as an image signal, as to cause the recording apparatus to start recording and to record the recording start point at the start of recording, so that the following effect can be attained. As the recording apparatus is caused to record the recording start point at the start of recording, in case such recording apparatus is used for recording the image signal such as the signal of the TV telephone, the recorded message can be reproduced by the operations on the communication apparatus only.

Also the control means executes such control, in case the communication information is identified as an image signal, as to cause the recording apparatus to start recording and to record identification information for recognizing the recording start point at the start of recording, so that the following effect can be attained. As the recording apparatus is caused to record the identification information for recognizing the recording start point at the start of recording, in case such recording apparatus is used for recording the image signal such as the signal of the TV telephone, the recorded message can be reproduced by the operations on the communication apparatus only.

Also the recording apparatus is provided with transmission means for transmitting the communication information and the control means executes such control as to enable the recording apparatus for recording through the transmission means, so that the following effect can be attained. In case of reception of the communication information, the recording apparatus capable of recording the communication information is enabled for recording through the transmission means, whereby such recording apparatus can be utilized for recording the image signal such as the signal of the TV telephone and the message recording for the TV telephone can be realized even if the communication apparatus itself is not provided with the function of recording the image signal.

Also the transmission means transmits the communication information according to the IEEE 1394-based interface standard, so that the following effect can be attained. In a system capable of signal transmission from the communication apparatus to the recording apparatus through the IEEE 1394-based interface, such recording apparatus can be utilized for recording the image signal such as the signal of the TV telephone and the message recording for the TV telephone can be realized even if the communication apparatus itself is not provided with the function of recording the image signal.

Also the communication apparatus, being applicable to the message telephone, provides the following effect. The recording apparatus can be utilized for recording the image signal such as the signal of the TV telephone and the message recording for the TV telephone can be realized even if the communication apparatus itself (message telephone) is not provided with the function of recording the image signal. Also in case such recording apparatus is used for recording the image signal such as the signal of the TV telephone, the recorded message can be reproduced by the operations on the communication apparatus (message telephone) only.

Also the recording apparatus, being a magnetic recording apparatus, provides the following effect. The magnetic recording apparatus can be utilized for recording the image signal such as the signal of the TV telephone and the message recording for the TV telephone can be realized even if the communication apparatus itself (message telephone) is not provided with the function of recording the image signal. Also in case such magnetic recording apparatus is used for recording the image signal such as the signal of the TV telephone, the recorded message can be reproduced by the operations on the communication apparatus (message telephone) only.

Also the recording apparatus, being a video tape recorder, provides the following effect. The video tape recorder can be utilized for recording the image signal such as the signal of the TV telephone and the message recording for the TV telephone can be realized even if the communication apparatus itself (message telephone) is not provided with the function of recording the image signal. Also in case such video tape recorder is used for recording the image signal such as the signal of the TV telephone, the recorded message can be reproduced by the operations on the communication apparatus (message telephone) only.

Also the communication apparatus, being a hard disk device, provides the following effect. The hard disk device can be utilized for recording the image signal such as the signal of the TV telephone and the message recording for the TV telephone can be realized even if the communication apparatus itself (message telephone) is not provided with the function of recording the image signal. Also in case such hard disk device is used for recording the image signal such as the signal of the TV telephone, the recorded message can be reproduced by the operations on the communication apparatus (message telephone) only.

Also the memory medium of the present invention according to claim 21 is a computer readable memory medium storing a program for executing a communication information recording method applicable to the communication apparatus capable of receiving the communication information from the outside, wherein the communication information recording method comprises a discrimination step of discriminating the presence or absence of reception of the communication information, and a control step of enabling a recording apparatus capable of recording the communication information in case of reception thereof, thereby attaining following effects. In case of reception of the communication information, the recording apparatus capable of recording the communication information is enabled for recording, whereby such recording apparatus can be utilized for recording the image signal such as the signal of the TV telephone and the message recording for the TV telephone can be realized even if the communication apparatus itself is not provided with the function of recording the image signal.

### [3] Third Embodiment

In the following there will be explained the functions of a third embodiment.

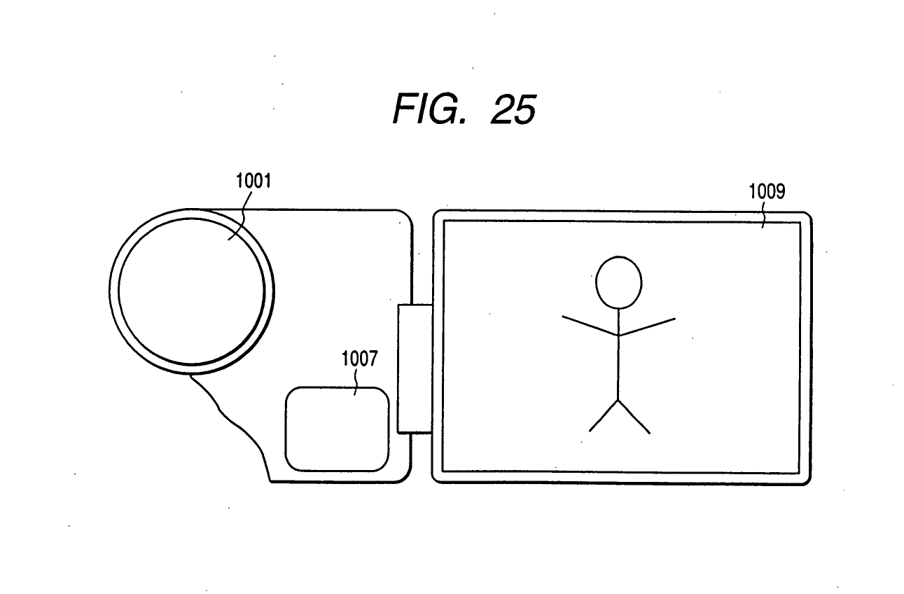

FIG. 25 is a block diagram of a video camera, wherein shown are a lens 1001 for entering the image of an object, a CCD 1002 for converting the image entered from the lens 1001 into an image signal, a camera signal process unit 1003 for effecting processes such as auto exposure on the image signal thereby converting into a digital video signal, a signal process unit 1004 for recording image/audio signals from the camera signal process unit 1003 and a microphone unit 1012 onto a magnetic tape by a VTR mechanism unit 1011 and reproducing signals from the magnetic tape for output to a line output unit 1005, a liquid crystal monitor 1007 and an 1394/F, a line output unit 1005 for line output of the signal from the signal process unit 1004, an 1394 I/F 1006 for outputting the image/audio signals from the signal process unit 1004 to a 1394 line, a microphone unit 1007 for entering the audio signal, a monitor control unit 1008 for outputting the signal from the signal process unit 1004 to a liquid crystal monitor 1009, a liquid crystal monitor 1009 for displaying the image signal from the monitor control unit 1008, a system control unit 1010 for controlling the entire video camera, an operation unit 1011 to be operated by an operator, a VTR mechanism unit 1012 for recording or reproducing the signal by the signal process unit 1004, and an audio signal 1012.

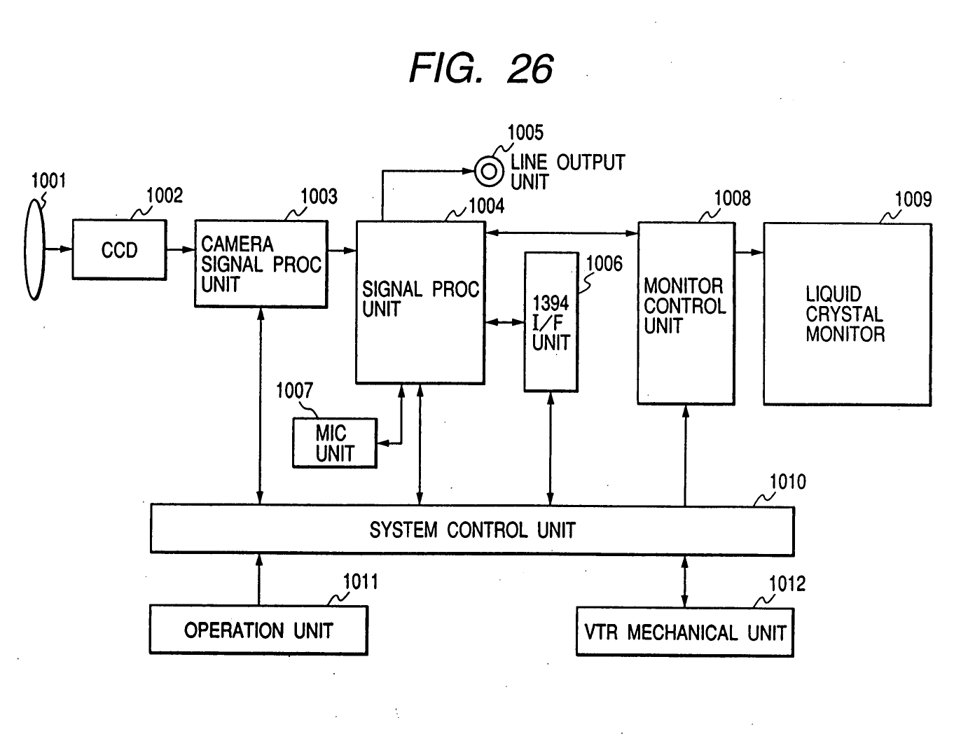

FIG. 26 is an external view of a video camera for which the operator himself constitutes the object, wherein shown a re a lens 1001 for entering the image of the object, a microphone unit 1007 for entering the audio signal, and a liquid crystal monitor 1009 for displaying the image signal.

At first, for preparing image/audio data to be used as the response in the message telephone, the operator operates the video camera shown in FIG. 25 through the operation unit 1011 to record the input signals from the lens 1001 and the microphone unit 1007 on the magnetic tape by the VTR mechanism unit 1012. In this operation, taking the image of the operator himself can be realized by executing the image taking with the observation of the liquid crystal monitor 1009 directed toward the object, whereby the image/voice of the operator himself can be prepared as the image/audio data as the response for the message telephone. Also in this operation, the signal process unit 1004 records, on thus recorded magnetic tape, an ID for recognizing the response message portion.

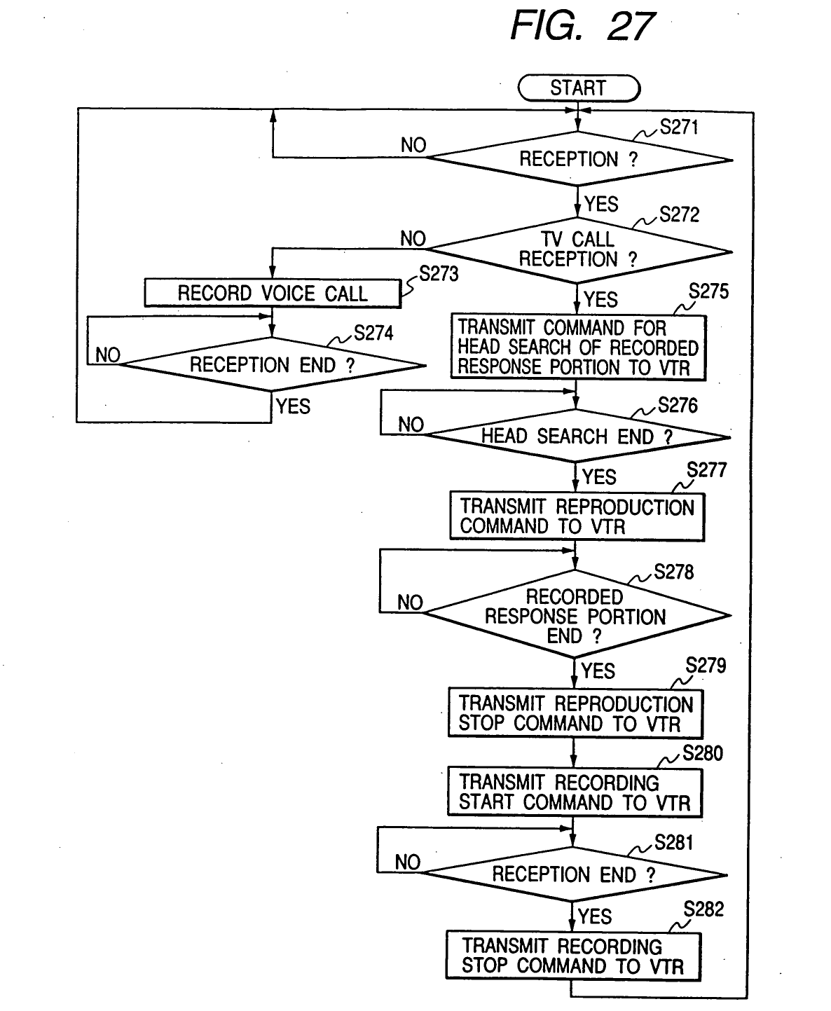

FIG. 27 is a flow chart showing the operations of the present embodiment.

In the following these operations will be explained with reference to the block diagram shown in FIG. 1.

In the message telephone, the system control unit 13 discriminates presence or absence of reception from the public line 1 (S271). If present, the system control unit 13 discriminates whether the reception is from a TV telephone (S272), and, if not, decodes the audio data from the line I/F 2 by the audio decoding unit 7 into an analog audio signal and causes the memory unit 27 to record the audio communication, thereby achieving the function of the ordinary message telephone (S273, S274). On the other hand, in case of the reception from the TV telephone, the image/audio data recorded in the VTR are reproducing as the response for the message telephone. For this purpose, the system control unit 13 transmits, through the 1394 I/F 16 to the VTR system control unit, a command for searching the recorded response message portion in order to reproducing such recorded response message portion. The control unit 24 of the VTR executes search in response to the command received from the 1394 I/F 17 through the data selector 18. Upon completion of the search, the VTR control unit 24 informs the system control unit 13 of the completion of the search through the 1394 I/F 17 (S275, S276).

Then the system control unit 13 transmits, through the 1394 I/F 16 to the VTR system control unit, a command for reproducing the recorded response message portion. The VTR control unit 24 executes the reproduction in response to the command received from the 1394 I/F 17 through the data selector 18. The VTR control unit 24 reproduces the audio/image signals from the magnetic tape by the head amplifier 20 and the head 21, and transmits the audio/image signals as 1394 communication packet data from the signal process unit 19 to the 1394 I/F 19. The system control unit 13 decodes the audio/image data through the packet data process unit 11 and the decoding unit 10 and outputs the recorded response message portion by the separation/multiplexing unit 3 and the line I/F 2, respectively through the decoding unit 7 for the audio signal and the decoding unit 4 for the image signal (S277).

Upon completion of reproduction of the recorded response message portion, the VTR control unit 24 informs the system control unit 13, through the 1394 I/F 17, of such completion of the reproduction.

The system control unit 13 executes control for transmitting a reproduction stop command from the packet data process unit 11 to the 1394 serial bus, and causes the 1394 I/F 16 to transmit such command. In response to the reproduction stop command received from the 1394 I/F 17 through the data selector 18, the VTR control unit 24 executes control on the signal process unit 19 for stopping the reproduction, thereby terminating the reproduction (S278, S279).

For recording the message, the system control unit 13 outputs the audio and image data from the line I/F 2 and the separation/multiplexing unit 3. The image data are decoded by the image decoding unit 4 and the image I/F, and encoded again into digital data by the image encoding unit 6. Also the audio/image data are decoded by the decoding unit 10, then formed in 1394 packet data by the packet data process unit 14 and the memory 12 and outputted by the 1394 I/F 16.

Also the system control unit 13 execute such control as to attach a command for executing recording and recording an ID for recognizing the recording start position to the audio/image signal on the 1394 serial bus in the packet generation unit 11.

Upon receiving the recording start command from the 1394 I/F 17 through the data selector 18, the VTR control unit 24 controls the data selector 18 so as to send the audio/image signal to the signal process unit 19, and causes the signal process unit 19 to execute signal processing for recording by the head amplifier 20 and the head 21 onto the magnetic tape, thereby recording the audio/image signal and the ID for recognizing the start position by the head 21 onto the magnetic tape (S280).

The system control unit 13 discriminates whether the reception of the TV telephone from the line I/F 2 has been terminated (S281), and, if terminated, the system control unit 13 executes control to transmit a recording stop command by the packet data process until 11 to the 1394 serial bus, thereby transmitting such command by the 1394 I/F 16. In response to the recording stop command received from the 1394 I/F 17 through the data selector 18, the VTR system control unit 24 control the signal process unit 19 to terminate recording (S282).

In reproducing the recorded message, for reproducing the signal of the TV telephone, the system control unit 13 of the message telephone, in response to an operation by the user on the operation unit 15, transmits a command for searching the recording start point and reproducing the recorded message to the 1394 serial bus from the packet generation unit 11 and the 1394 I/F 16. In response to the command received from the 1394 I/F 17 through the data selector 18, the VTR control unit 24 searches the recording start point and executes the reproduction.

The above-described operations are illustrated in the flow chart shown in FIG. 27.

As explained in the foregoing, the television camera capable of recording the image of the operator himself is utilized for recording the response message for the message telephone and the message in the call of the message telephone, so that the message recording function and the message response function for the TV telephone can be attained even when the telephone itself is provided with the function of recording and reproducing the image signal. Also the use of 1394 serial bus enables connection with the 1394 cable only.

In the present embodiment a VTR has been utilized as the medium for recording the image signal, but similar functions can be achieved with other magnetic recording media such as HDD or the like.

### Effect of the Invention

According to the above-described embodiment of the present invention, as explained in the foregoing, the television camera capable of recording the image of the operator himself is utilized for recording the response message for the message telephone and the message in the call of the message telephone, so that the message recording function and the message response function for the TV telephone can be attained even when the telephone itself is provided with the function of recording and reproducing the image signal. Also the use of 1394 serial bus enables connection with the 1394 cable only.

1. A communication apparatus capable of receiving communication information from and external source comprising:
discrimination means for discriminating presence or absence of reception of the communication information; and
control means for executing control, in a case of reception of the communication information, to set a recording apparatus capable of recording
wherein said control means executes control, in a case where the communication information is judged as an image signal, to cause the recording apparatus to start recording and to record the recording start point at the start of recording, and
wherein said communication apparatus and said recording apparatus are connected to each other through a network, and said control means executes a communication protocol of said network and transmits a command to start the recording for said recording apparatus.

2. A communication apparatus according to claim 1, wherein said discrimination means has a function of discriminating whether the communication information is an image signal, and said control means executes control, in case the communication information is judged as the image signal, to cause the recording apparatus to start recording.

3. (Cancelled)

4. A communication apparatus according to claim 1, wherein said control means executes control, in a case where the communication information is judged as the image signal, to cause the recording apparatus to start recording and to record identification information for recognizing the recording start point at the start of recording.

5. A communication apparatus according to claim 1, wherein said recording apparatus includes transmission means for transmitting said communication information, and said control means executes control, through said transmission means, to set the recording apparatus in a state capable of recording.

6. A communication apparatus according to claim 5, wherein said transmission means transmits said communication information according to the IEEE 1394-based interface standard.

7. A communication apparatus according to claim 6, wherein said communication apparatus is constructed to be usable as a message telephone.

8. A communication apparatus according to claim 1, wherein said recording apparatus is a magnetic recording apparatus.

9. A communication apparatus according to claim 8, wherein said recording apparatus is a video tape recorder.

10. A communication apparatus according to claim 8, wherein said recording apparatus is a hard disk device.

11. A communication information recording method adapted for use in a communication apparatus capable of receiving communication information from an external source, the method comprising:
a discrimination step of discriminating presence or absence of reception of the communication information; and
a control step of executing control, in case of reception of the communication information to set a recording apparatus capable of recording
wherein said control step includes executing control, in a case where the communication information is judged as an image signal, to cause the recording apparatus to start recording and to record the recording start point at the start of recording, and
wherein said communication apparatus and said recording apparatus are connected to each other through a network, and said control step executes control using a communication protocol of said network and transmits a command to start the recording for said recording apparatus.

12. A communication information recording method according to claim 11, wherein said discrimination step has a function of discriminating whether the communication information is an image signal, and said control step includes executing control, in a case where the communication information is judged as the image signal, to cause the recording apparatus to start recording.

13. (Cancelled)

14. A communication information recording method according to claim 11, wherein said control means executes control, in case the communication information is judged as the image signal, to cause the recording apparatus to start recording and to record identification information for recognizing the recording start point at the start of recording.

15. A communication information recording method according to claim 11, further comprising a transmission step of transmitting said communication information to the recording apparatus, wherein the control step includes executing control, through said transmission step, to set the recording apparatus in a state capable of recording.

16. A communication information recording method according to claim 15, wherein said transmission step includes transmitting said communication information according to the IEEE 1394-based interface standard.

17. A communication information recording method according to claim 11, wherein the communication apparatus is a message telephone.

18. A communication information recording method according to claim 11, wherein the recording apparatus is a magnetic recording apparatus.

19. A communication information recording method according to claim 11, wherein the recording apparatus is a video tape recorder.

20. A communication information recording method according to claim 11, wherein the said recording apparatus is a hard disk device.

21. A computer readable memory medium storing a program for executing a communication information recording method adapted for use in a communication apparatus capable of receiving communication information from an external source, the method comprising
a discrimination steps of discriminating presence or absence of reception of the communication information; and
a control step, of executing control, in a case of reception of the communication information, to set a recording apparatus capable of recordings
wherein said control step includes executing control, in a case, the communication information where the communication information is judged as an image signal, to cause the recording apparatus to start recording and to record the recording start of recording, and
wherein said communication apparatus and said recording apparatus are connected to each other through a network, and said control step executes control using a communication protocol of said network and transmits a command to start the recording for said recording apparatus.
